(19) United States
(12) Patent Application Publication
(10) Pub. No.: US 2014/0023518 A1
(43) Pub. Date: Jan. 23, 2014

(54) TIRE VALVE - MICRO AIR PUMP

(71) Applicants: Timothy F. O'Brien, White Lake, MI (US); Daniel Vern Beckley, Byron, MI (US)

(72) Inventors: Timothy F. O'Brien, White Lake, MI (US); Daniel Vern Beckley, Byron, MI (US)

(73) Assignee: MAGNA INTERNATIONAL INC., Aurora (CA)

(21) Appl. No.: 14/005,197

(22) PCT Filed: Apr. 11, 2012
(86) PCT No.: PCT/US12/33066

§ 371 Date: Sep. 13, 2013

Related U.S. Application Data
(60) Provisional application No. 61/516,943, filed on Apr. 11, 2011.
(60) Provisional application No. 61/627,747, filed on Oct. 17, 2011.

(51) Int. Cl. B60S 5/04

(52) U.S. Cl. CPC B60S 5/046
USPC 417/1; 152/415; 152/427

(57) ABSTRACT

An automatic micro-pump which is able to replace the depleted air in a tire without any required action from the driver of a motor vehicle. Using the kinetic energy of the rotating tire, the micro-pump maintains the tire pressure from losses due to rubber permeability or temperature changes. The micro pump has an off-balance winding wheel (26) and a primary gear set (50). The off-balance winding wheel drives the primary gear set (50), and a secondary gear set (58) connected to and driven by the primary gear set (50). A pump assembly (86) is connected to and driven by the secondary gear set (58) such that as the off-balance winding wheel rotates, the off-balance winding wheel drives the primary gear set (50), and the primary gear set (50) drives the secondary gear set (58), driving the pump and increasing the air pressure in the tire. The pump assembly (86) draws air from the atmosphere, and forces the air into the tire.

### CROSS REFERENCE TO RELATED APPLICATIONS

This application is a PCT International application claiming priority to U.S. Application No. 61/516,943 filed on Apr. 11, 2011 and U.S. Application No. 61/627,747 filed on Oct. 17, 2011.

### FIELD OF THE INVENTION

The present invention relates to a micro-pump used for maintaining proper tire pressure in a vehicle tire without any required action from the driver of the vehicle.

### BACKGROUND OF THE INVENTION

Most vehicles have tires that are inflated with air to a specific pressure to optimize the life of the tire and fuel economy. Underinflated tires resulting from material permeability and temperature changes cost millions of dollars in fuel economy and premature tire wear every year.

Many different types of devices, such as self-regulating tire pumps, have been created to maintain an optimal tire pressure. However, these products are either mechanically unfeasible or financially prohibitive for commercialization. There are on-board tire pressure management systems which have a central compressor, but these systems require radical changes to the vehicle in order to operate. These can be found on military or commercial-type vehicles where cost is not as much of a concern. Most products in the aftermarket serve only to warn the driver of low pressure but commercial-type vehicles where cost is not as much of a concern. Most products in the aftermarket serve only to warn the driver of low pressure but have no means of automatically replacing the air in the tire in the event of a reduction in tire pressure.

Accordingly, there exists a need for an improved way of maintaining the air pressure in the tires of a vehicle without any required action from the driver.

### SUMMARY OF THE INVENTION

The present invention is directed to an automatic micro-pump which is able to replace the depleted air in a tire without any required action from the driver. The micro-pump of the present invention does not require any modifications to existing technologies on the vehicle such as wheels and/or tires and simply replaces a standard tire valve. Using the kinetic energy of the rotating tire, the micro-pump of the present invention maintains the tire pressure from losses due to rubber permeabilty or temperature changes.

In one embodiment, the micro-pump of the present invention is for use with a tire, and has a casing which includes an upper half and a lower half, an off-balance winding wheel rotatably disposed in the casing, and a primary gear set. The off-balance winding wheel is operable for driving the primary gear set, and a secondary gear set is connected to and driven by the primary gear set. The off-balance winding wheel is driven by the kinetic energy of the tire, such as the starting and stopping motions of the tire, the tire rolling slowly, and wheel bounce.

A piston pump assembly is connected to and driven by the secondary gear set such that as the off-balance winding wheel rotates, the off-balance winding wheel drives the primary gear set, and the primary gear set drives the secondary gear set, driving the piston pump and increasing the air pressure in the tire. The piston pump assembly draws air from the atmosphere, and forces the air into the tire.

The primary gear set and the secondary gear set allow the winding wheel to have a mechanical advantage to crank the piston pump assembly. This allows the micro-pump of the present invention to be used with almost any type of tire when used in conjunction with a pressure regulator.

In an alternate embodiment, other devices besides the off-balance winding wheel are used for driving the gear sets and the piston pump assembly. They include, but are not limited to, fan blades, a venturi, a pendulum, or electromechanical methods.

In a second embodiment, the primary gear set and the secondary gear set allow the winding wheel to have a mechanical advantage to wind a cam, where the cam and a diaphragm pump generate a pumping action. This allows the micro-pump of the present invention to be used with almost any type of tire when used in conjunction with a pressure regulator.

In an alternate embodiment, other devices besides the off-balance winding wheel are used for driving the gear sets and the diaphragm pump. They include, but are not limited to, fan blades, a venturi, a pendulum, or electromechanical methods.

In another alternate embodiment, other types of pumps may be used instead of the diaphragm pump assembly and the piston pump assembly. Other types of pumps which may be used include, but are not limited to, turbine pumps, centrifugal pumps, rotary pumps, peristaltic pumps, or electromechanical pumps.

In another alternative embodiment, an electroactive polymer material is used inside the tire and/or on the valve stem of the tire to create an electrical charge to be used as needed to by the pump.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a sectional perspective view of a tire having a micro- pump, according to the present invention;

FIG. 2 is a perspective view of a micro-pump, according to the present invention;

FIG. 3 is a sectional view of a tire having a micro-pump, according to the present invention;

FIG. 4 is an enlarged sectional view of a micro-pump, according to the present invention;

FIG. 5 is a perspective view of a micro-pump with the upper half of the casing removed, having only the winding wheel installed, according to the present invention;

FIG. 6 is a perspective view of a micro-pump with the upper half of the casing removed, having only the winding wheel installed, with the winding wheel shown in phantom, according to the present invention;

FIG. 7 is a perspective view of a micro-pump with the upper half of the casing removed, having the winding wheel and planetary gear set installed, according to the present invention;

FIG. 8 is a perspective view of a micro-pump with the upper half of the casing removed, having the winding wheel, planetary gear set, primary gear, and ring gear installed, according to the present invention;

FIG. 9 is an enlarged perspective view of a micro-pump with the upper half of the casing removed, having the winding wheel, planetary gear set, primary gear, and ring gear installed, with the ring gear and primary gear shown in phantom, according to the present invention;

FIG. 10 is a perspective view of a micro-pump with the upper half of the casing removed, having the winding wheel, planetary gear set, primary gear, ring gear, and secondary gear installed, according to the present invention;

FIG. 11 is a perspective view of a micro-pump with the upper half of the casing removed, having the winding wheel, planetary gear set, primary gear, ring gear, worm gear, first bevel gear, second bevel gear, and secondary gear installed, with the secondary gear shown in phantom, according to the present invention;

FIG. 12 is a perspective view of a micro-pump with the upper half of the casing removed, having the winding wheel, planetary gear set, primary gear, ring gear, worm gear, first bevel gear, second bevel gear, secondary gear, and crank gear installed, according to the present invention;

FIG. 13 is a perspective view of a micro air pump with the upper half of the casing removed, having the winding wheel, planetary gear set, primary gear, ring gear, worm gear, first bevel gear, second bevel gear, secondary gear, crank gear, and a partial piston pump assembly installed, according to the present invention;

FIG. 14 is a top view a micro air pump with the upper half of the casing removed, and all of the parts of the pump installed, according to the present invention;

FIG. 15A is a top view of a micro air pump with the upper half of the casing removed, and the secondary gear and first bevel gear removed, according to the present invention;

FIG. 15B is an enlarged view of the circled portion of FIG. 15A;

FIG. 16 is a perspective view of a micro air pump with various components shown in phantom, according to the present invention;

FIG. 17 is a sectional view of a first alternate embodiment of micro-pump in the form of a rotary screw pump, according to the present invention;

FIG. 18 is perspective view of a second alternate embodiment of micro-pump in the form of a rotary screw pump, according to the present invention;

FIG. 19 a perspective view of another alternate embodiment of a micro-pump having a winding wheel which spins two turbines, according to the present invention; and

FIG. 20 is a sectional view of another alternate embodiment of a micro-pump having a diaphragm pump and storage tank, according to the present invention.

FIG. 21 is a sectional perspective view of a tire having a micro-pump, according to another embodiment of the present invention;

FIG. 22 is a perspective view of a micro-pump, according to the present invention;

FIG. 23 is a sectional view of a tire having a micro-pump, according to the present invention;

FIG. 24 is a top view of a micro-pump with the upper half of the casing removed, according to the present invention;

FIG. 25 is a sectional top view of a micro-pump, according to the present invention;

FIG. 26 is a perspective view of a micro-pump with the upper half of the casing removed, showing the main air tube, the fill air tube, and the winding wheel mounted to the hub, according to the present invention;

FIG. 27 is a perspective view of a micro-pump with the upper half of the casing removed, showing the main air tube, the fill air tube, and the winding wheel mounted to the hub, with the winding wheel shown in phantom, according to the present invention;

FIG. 28 is a perspective view of a micro-pump with the upper half of the casing removed, showing the winding wheel, planetary gear set, the hub, main air tube, and fill air tube, according to the present invention;

FIG. 29 is a perspective view of a micro-pump with the upper half of the casing removed, showing the winding wheel, planetary gear set, ring gear, worm gear, main air tube, and the fill air tube, with the ring gear and worm gear shown in phantom, according to the present invention;

FIG. 30 is an enlarged perspective view of a micro-pump with the upper half of the casing removed, showing the winding wheel, planetary gear set, ring gear, worm gear, hub, main air tube, and the fill air tube, according to the present invention;

FIG. 31 is a perspective view of a micro-pump with the upper half of the casing removed, with the diaphragm pump removed, and the spring removed from the hub, according to the present invention;

FIG. 32 is a perspective view of a micro-pump with the upper half of the casing removed, and the diaphragm pump removed, according to the present invention;

FIG. 33 is a perspective view of a micro-pump with the upper half of the casing removed, according to the present invention;

FIG. 34A is a second top view of a micro-pump with the upper half of the casing removed, according to the present invention;

FIG. 34B is an enlarged top view a regulator valve used as part of a micro-pump, according to the present invention;

FIG. 35 is a perspective view of winding wheel and bevel gears used as part of an alternate embodiment of a micro-pump, according to the present invention;

FIG. 36 is a front view of a bi-directional winding mechanism, used as part of an alternate embodiment of a micro-pump, according to the present invention;

FIG. 37 is a perspective view of an alternate embodiment of a micro-pump having an electronic actuator, according to the present invention;

FIG. 38 is a schematic flowchart illustrating the process of an automatic micro-pump for replacing the depleted air in a tire;

FIG. 39 is a sectional perspective view of a tire having an alternate embodiment of a micro-pump having an electroactive polymer, according to the present invention;

FIG. 40 is a sectional perspective view of a tire including a micro-pump having an electroactive polymer, according to the present invention; and

FIG. 41 is a sectional front view of a tire having an alternate embodiment of a micro-pump having an electroactive polymer, according to the present invention.

### DETAILED DESCRIPTION OF THE PREFERRED EMBODIMENTS

The following description of the preferred embodiment(s) is merely exemplary in nature and is in no way intended to limit the invention, its application, or uses.

Referring to the Figures generally, an embodiment of a micro-pump according to the present invention is shown generally at 10. The pump 10 is mounted to the outer radius 12 of a rim 14, and is located inside a cavity 16 formed by the rim 14 and a tire 18. The pump 10 may be used in place of a typical tire valve, without requiring any modification to the rim 14.

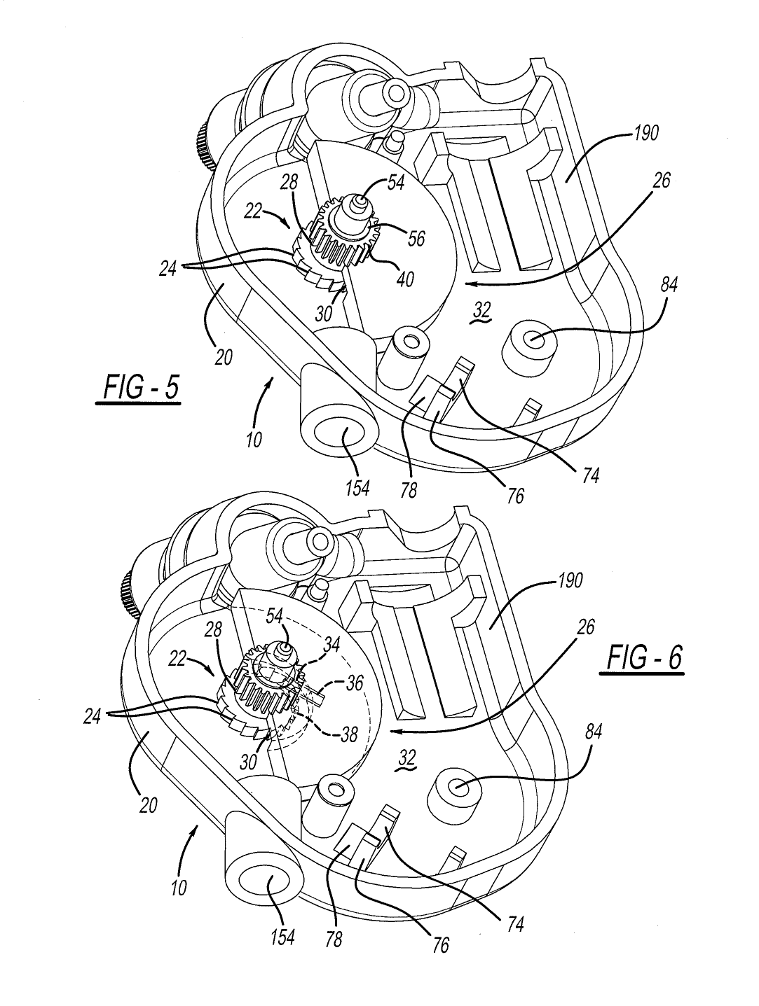

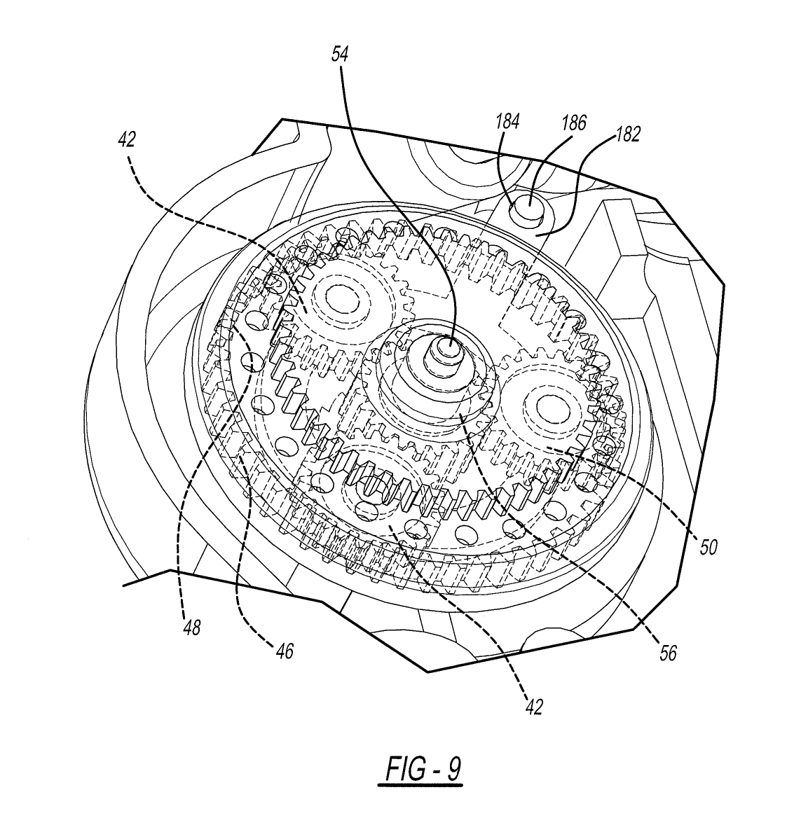

The pump 10 has a body portion or casing 20, which has various apertures and contours to accommodate the various parts of the pump 10. The casing 20 has an upper half 128 and a lower half 190, and in FIGS. 5-14, the upper half 128 of the casing 20 has been removed to reveal the various components of the pump 10. Referring to FIGS. 5 and 6, formed as part of the casing 20 is a circular protrusion, shown generally at 22, having a plurality of stepped features 24. Mounted on top of the protrusion 22 is an off-balance winding wheel, shown generally at 26. The off-balance winding wheel 26 includes a bearing portion 28 which contacts the protrusion 22, such that the protrusion 22 is received into a recessed portion 30 formed as part of the wheel 26.

The wheel 26 rests on the bearing portion 28, which allows the wheel 26 to spin freely. Formed as part of the recessed portion 30 is an inner wall 34. The inner wall 34 has a slot 36 which is used for receiving a flange 38. The flange 38 extends away from the inner wall 34 towards the protrusion 22 such that the flange 38 extends toward and selectively contacts one of the stepped features 24, which allows the wheel 26 to spin in only one direction. Also formed as part of the wheel 26 is a sun gear 40 which is in axial alignment with the bearing portion 28.

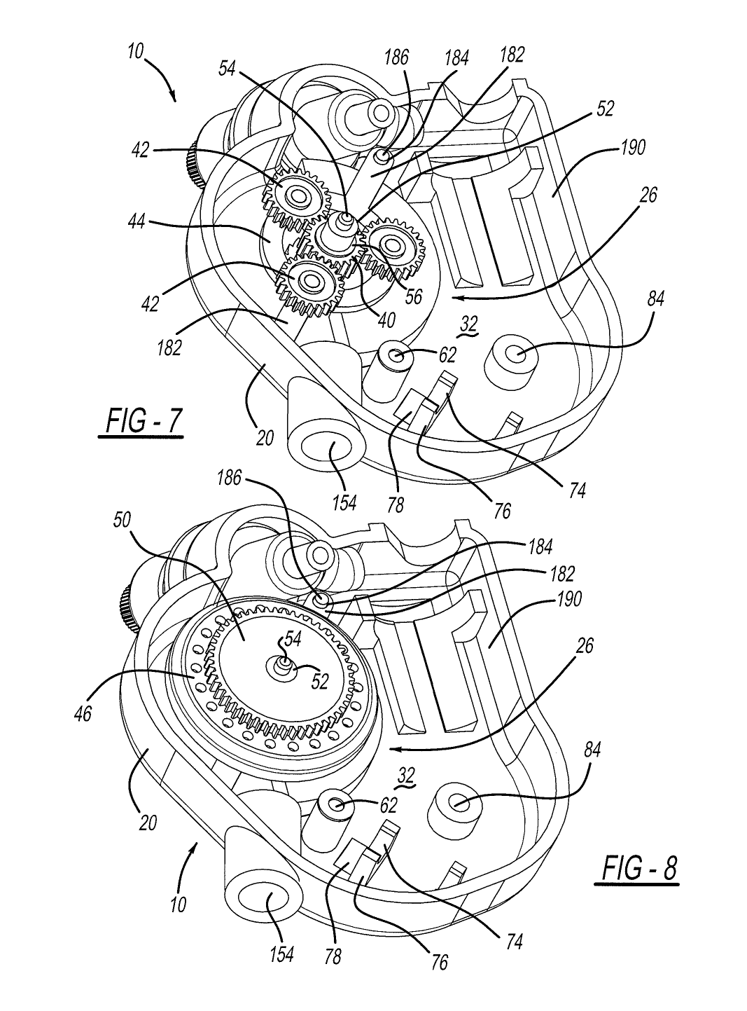

Referring to FIGS. 7-9, in mesh with the sun gear 40 is a plurality of planetary gears 42 which are mounted on a carrier 44. The planetary gears 42 are also in mesh with a ring gear 46 having internal teeth 48. The planetary gears 42 transfer rotation to the ring gear 46 at about a 3.5:1 gear ratio. Mounted to the ring gear 46 is a primary gear 50, and the primary gear 50 rotates with the ring gear 46. The sun gear 40, planetary gears 42, ring gear 46 and primary gear 50 all form a primary gear set. The ring gear 46 and primary gear 50 are allowed to rotate because of a bearing 52 mounted on a shaft 54. Also mounted to the shaft 54 is a second bearing 56, upon which the sun gear 40 is mounted, which allows the sun gear 40 to rotate relative to the ring gear 46. The shaft 54 is long enough to extend into a recess formed as part of a bottom surface 32 of the casing 20, and into another recess formed as part of the upper half 128 of the casing 20, which as mentioned above has been removed from FIGS. 5-15.

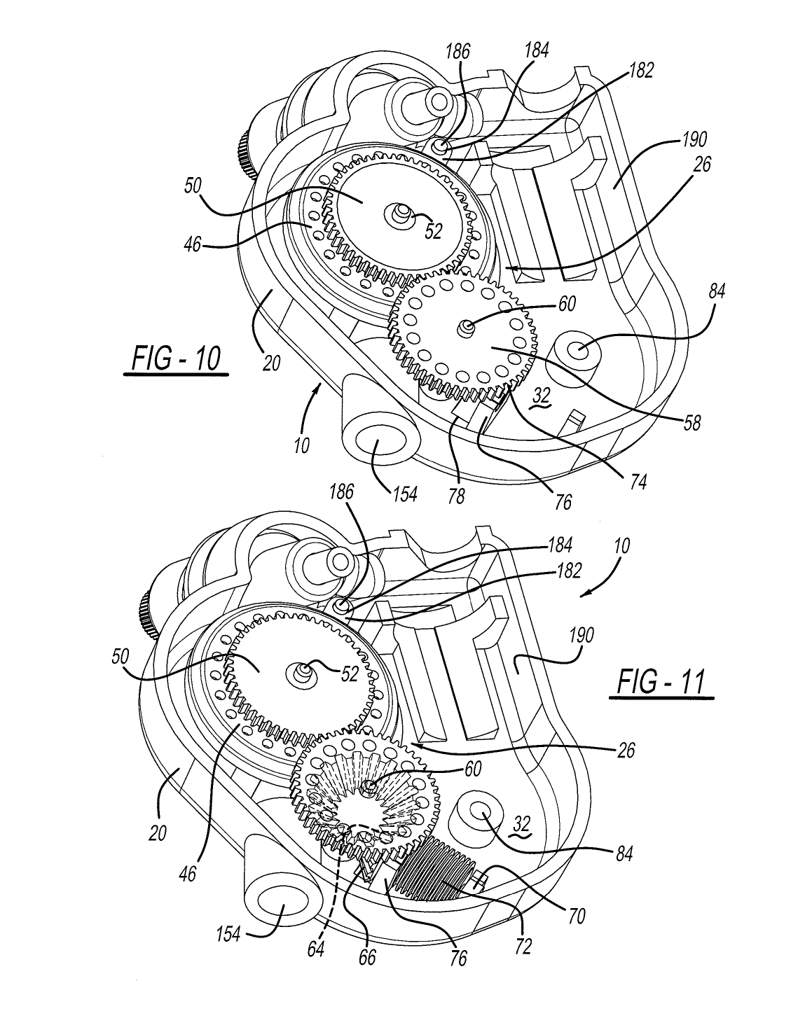

Referring to FIGS. 10-11, the primary gear 50 is in mesh with a secondary gear 58, the secondary gear 58 is mounted on a shaft 60, and the shaft 60 extends into an aperture 62 (shown in FIGS. 7-8), which is also formed as part of the bottom surface 32 of the casing 20. The primary gear 50 and the secondary gear 58 rotate at a 1:1 gear ratio. Integrally formed with the secondary gear 58 is a first bevel gear 64, and the shaft 60 extends from the aperture 62 through the first bevel gear 64 shown in FIG. 11 and through the secondary gear 58 and protrudes outwardly from the secondary gear 58 and extends into a recess formed as part of the upper half 128 of the casing 20.

The first bevel gear 64 is in mesh with a second bevel gear 66, and the second bevel gear 66 is mounted on a shaft 68. Also mounted on the shaft 68 is a pair of bearings 70, and mounted to the shaft 68 between the bearings 70 is a worm gear 72. The bearings 70 are positioned in respective semi-circular recesses 74, and each semi-circular recess 74 is formed as part of a post portion 76. Formed as part of the bottom surface 32 of the casing 20 is another recess 78, which a portion of the second bevel gear 66 extends into.

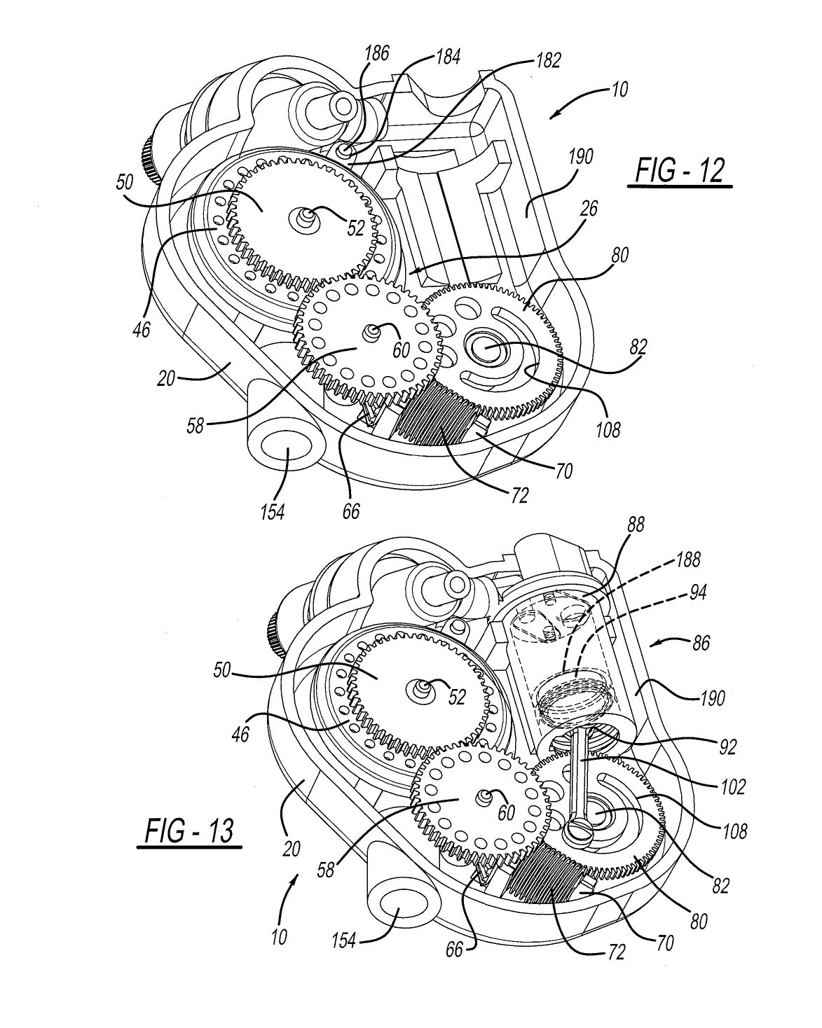

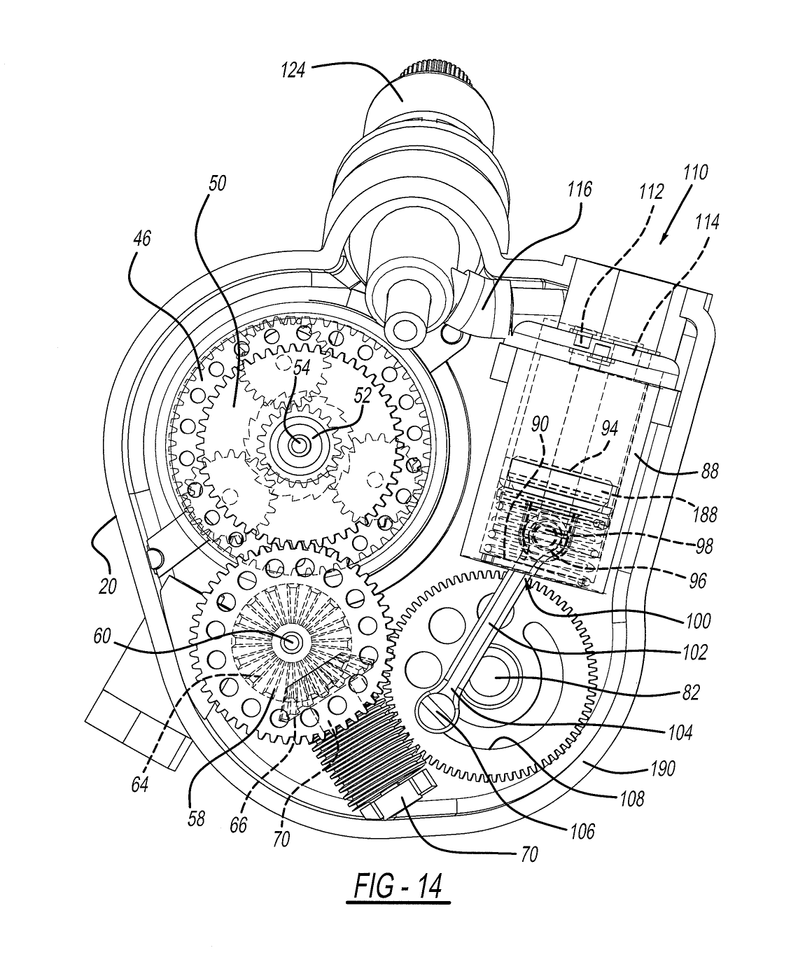

Referring to FIGS. 12-14, the worm gear 72 is in mesh with a crank gear 80, and the crank gear 80 is also mounted on a shaft 82 which extends into a recess 84 (shown in FIGS. 5-8) formed as part of the bottom surface 32 of the casing 20. The secondary gear 58, the bevel gears 64,66, the worm gear 72, and the crank gear 80 for a secondary gear set. The worm gear 72 rotates the crank gear 80 at a 95:1 gear ratio. Other gear ratios may be used to provide a mechanical advantage which allows the pump to be effective. The crank gear 80 is connected to a spring loaded piston pump assembly, generally shown at 86. The assembly 86 includes a piston sleeve 88, which is substantially hollow, but includes a bottom surface 90 which supports a spring 92. The spring 92 is in contact with the bottom surface of a piston 94, and the piston 94 is slidably disposed in the piston sleeve 88. The piston 94 has a piston seal 188 that surrounds the piston 94 and is in sliding contact with the piston sleeve 88 such that air does not flow around the piston 94 as the piston 94 moves in the piston sleeve 88. The piston 94 also includes a pair of flanges 96, and a pin 98 extends through the flanges 96 and a first end, shown generally at 100, of a connecting arm 102. The connecting arm 102 is therefore pivotally connected to the piston 94. On a second end 104 of the connecting arm 102 is a pin 106 which extends through the second end 104 of the arm 102 into a slot 108 formed as part of the crank gear 80. The slot 108 formed as part of the crank gear 80 allows for the piston 94 to freely move in the piston sleeve 88 once the piston 94 has been moved to the bottom of its stroke, best shown in FIG. 14.

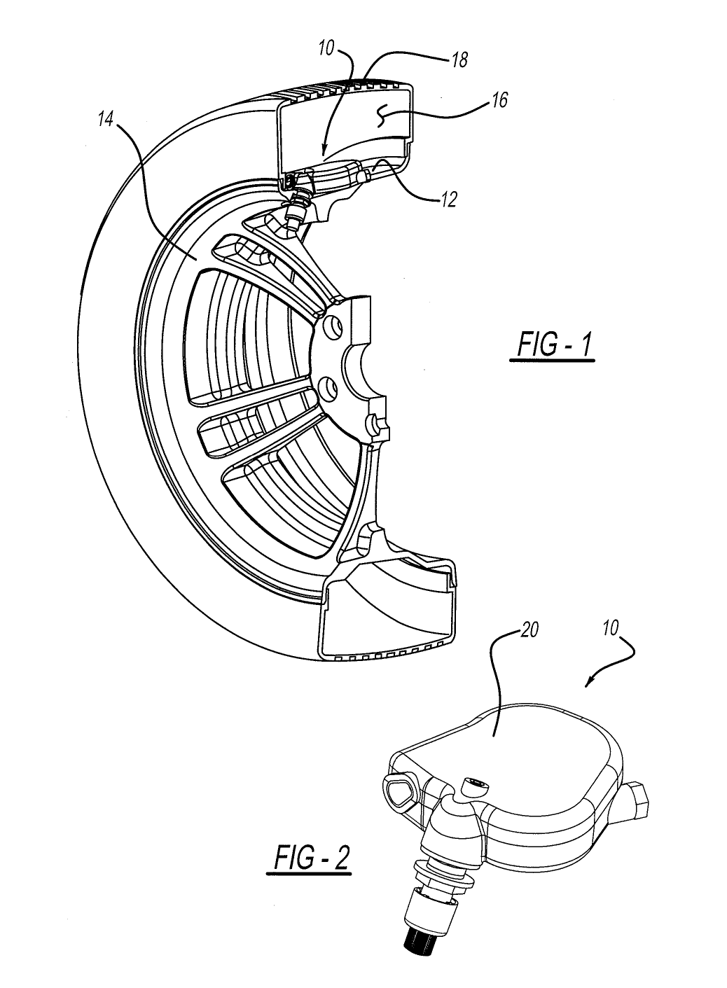

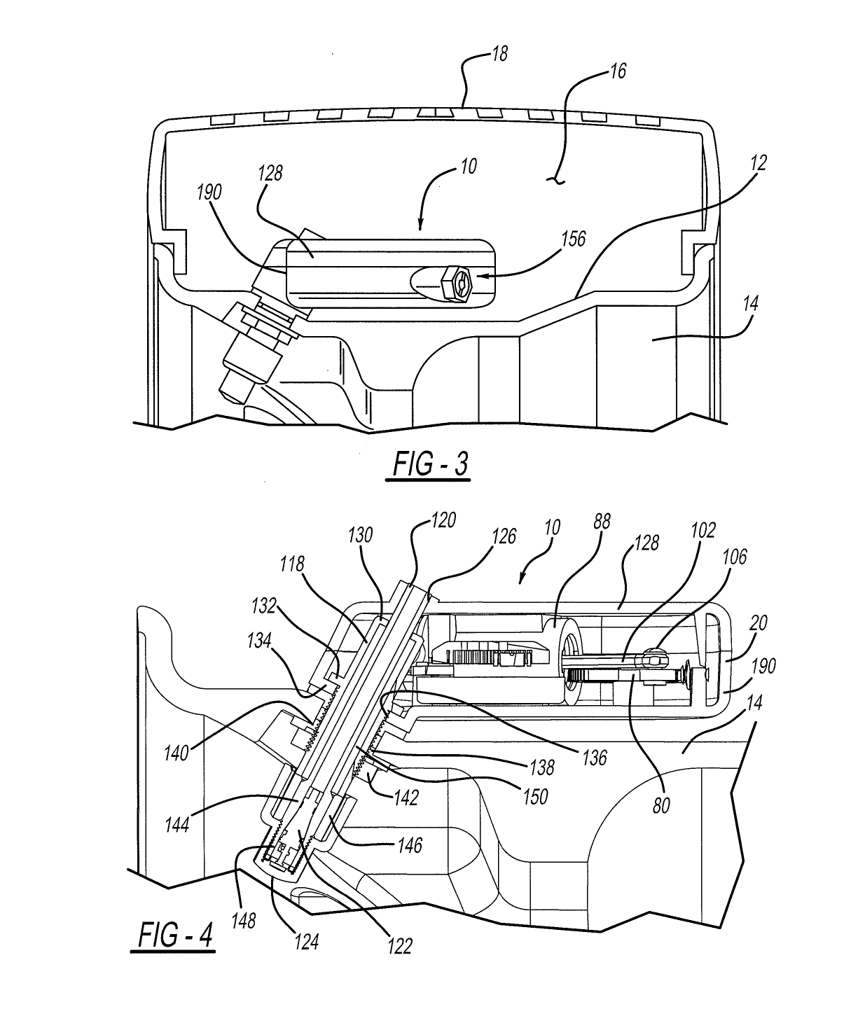

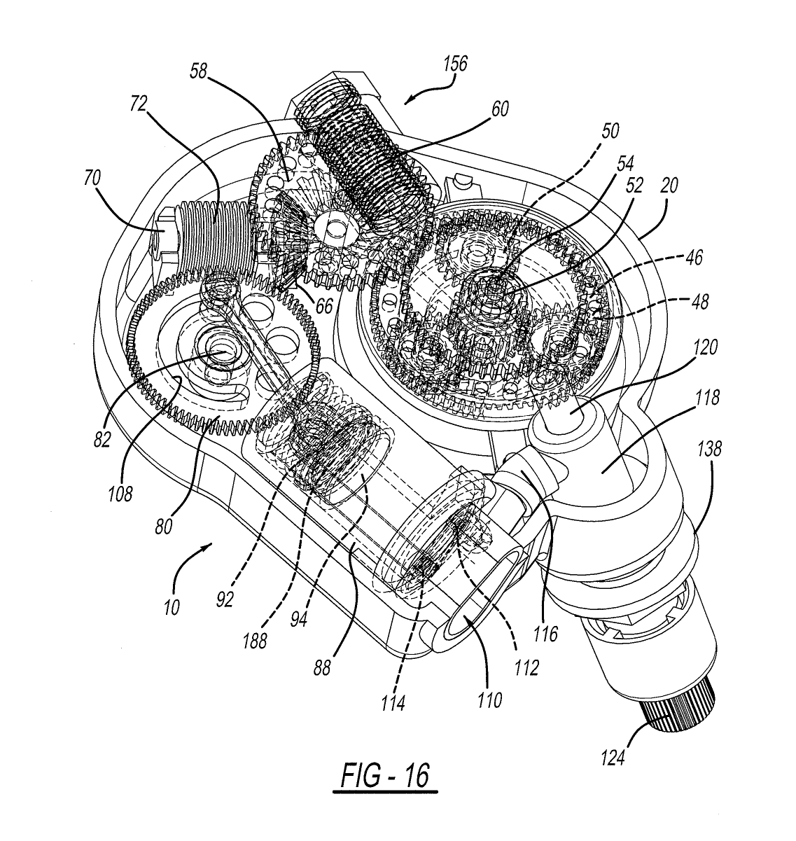

Referring to FIGS. 14-16, connected to the piston sleeve 88 is a manifold housing, shown generally at 110, which has an intake valve 112 and an outlet valve 114. The intake valve 112 is in fluid communication with an intake hose 116 and the piston sleeve 88, and the outlet valve 114 is in fluid communication with the piston sleeve 88 and the cavity 16 shown in FIGS. 1 and 3. The intake valve 112 and outlet valve 114 are one-way valves, the intake valve 112 allows the flow of air from outside of the tire 18 into the sleeve 88 as the piston 94 has moved toward the bottom of its stroke, but does not let air out as the piston 94 moves toward the top of its stroke. Conversely, the outlet valve 114 allows air to escape the sleeve 88 into the cavity 16 of the tire 18 as the piston 94 moves toward the top of its stroke, but does not let air flow from the cavity 16 into the sleeve 88 as the piston 94 moves towards the bottom of its stroke.

Referring to FIG. 4, the intake hose 116 is connected to and is in fluid communication with an outer cylinder 118. The outer cylinder 118 is hollow, and surrounds an inner cylinder or main air tube 120. The main air tube 120 includes a valve stem 122 and a cap 124, and extends from outside of the rim 14, through the rim 14, and the pump 10 such that an end of the tube 120 is exposed in the cavity 16. The tube 120 also extends through an aperture 126 formed in the upper half 128 of the casing 20 to expose the tube 120 to the cavity 16.

The outer cylinder 118 has a rear wall 130 which is in contact with and extends perpendicularly away from the main air tube 120. The outer cylinder 118 also has a flange 132 in contact with a flange 134 formed as part of the casing 20 such that the outer cylinder 118 and main air tube 120 are able to extend through an aperture 136. In contact with the flange 134 is a rubber seal 138 which is positioned in an aperture 140 formed as part of the rim 14 to prevent air from leaking out of the cavity 16. The rubber seal 138 is also in contact with a nut 142. The outer surface of the outer cylinder 118 is threaded, and the nut 142 is screwed onto the outer cylinder 118 as shown in FIG. 4. The connection between the nut 142 and rubber seal 138, as well as the contacting relationship between the flanges 132,134, maintains the position of the outer cylinder 118 relative to the pump 10 and the rim 14.

Surrounding a plurality of ribs 144 formed as part of the main air tube 120 is a filter 146, and surrounding a small diameter portion 148 of the main air tube 120 is the cap 124. The plurality of ribs 144 provide for proper positioning of the filter 146 while still allowing air to pass into the cavity 150. The cap 124 may be removed and the tire 18 may be filled with air using the valve stem 122 and main air tube 120. Additionally, air may pass through the filter 146 and the outer cylinder 118 in the cavity 150 formed by the outer cylinder 118 surrounding the main air tube 120 and into the intake hose 116, where the air may be forced into the tire 18 by the pump 10, the function of which will be described later.

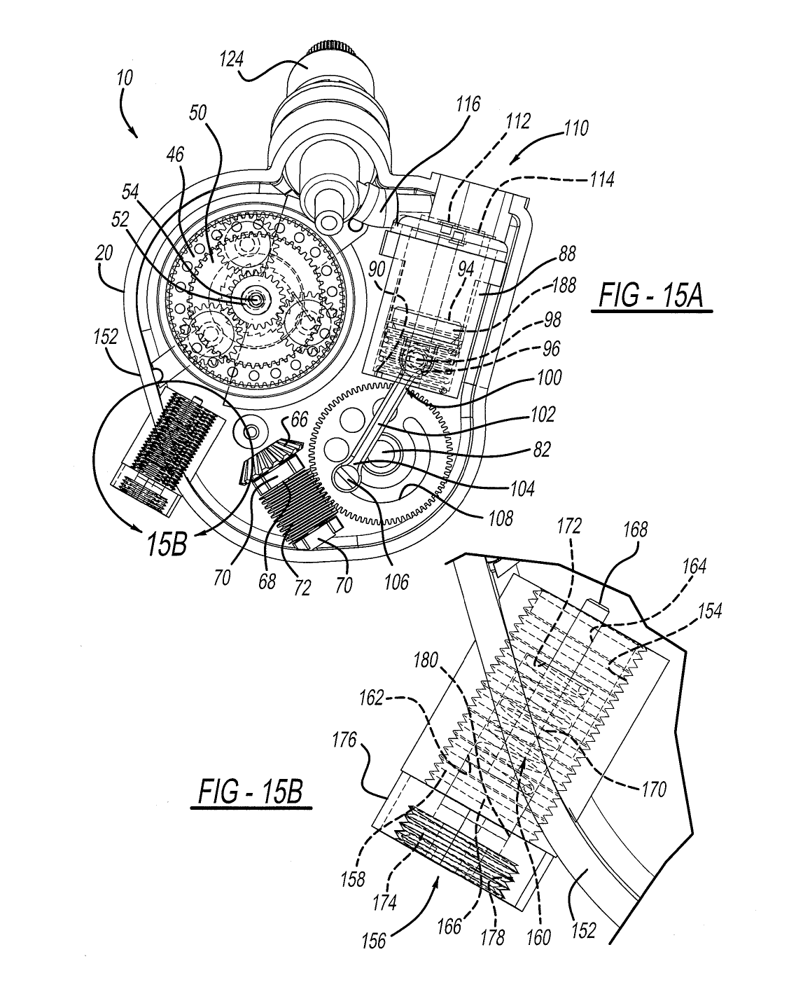

Referring to FIGS. 15A and 15B, formed in the side wall 152 is a threaded aperture 154 which receives a regulator valve, shown generally at 156. The regulator valve 156 includes a threaded body portion 158 which is received into the threaded aperture 154. The threaded body portion 158 has an aperture, shown generally at 160. The aperture 160 has a large diameter portion 162 and a small diameter portion 164. Slideably disposed within the large diameter portion 162 is a plunger 166, and extending from the plunger 166 is a shaft 168, the shaft 168 extends through both diameter portions 162,164 and out of the small diameter portion 164 into the pump 10 in an area proximate to the winding wheel 26. Also disposed within the large diameter portion 162 is a spring 170 in between the bottom surface 172 of the large diameter portion 162 and the plunger 166. A cap 174 is connected to a mounting block 176 having an outer recess 178 for at least partially receiving the cap 174, and an inner recess 180, which the plunger 166 is operable for slidably extending through.

Referring again to the Figures generally, in operation, the pressure from the air inside the cavity 16 applies pressure to the plunger 166 through a hole in the cap 174. If the pressure applied to the plunger 166 is less than the force applied to the plunger 166 from the spring 170, the plunger 166 is moved into the inner recess 180 of the mounting block 176, and the shaft 168 is moved away from the winding wheel 26 and into the small diameter portion 164 of the aperture 160. The winding wheel 26 is then allowed to rotate. As the tire 18 and rim 14 rotate during vehicle travel, the change in position of the tire 18 and rim 14 change the position of the winding wheel 26 such that the winding wheel 26 rotates. As the winding wheel 26 rotates, the sun gear 40 rotates as well, which in turn rotates the planetary gears 42. The carrier 44 does not rotate because of a pair of extensions 182, which are formed as part of the carrier 44, having apertures 184, where a respective post 186 extends through one of the apertures 184. The posts are integrally formed as part of the casing 20.

The planetary gears 42 rotate the ring gear 46, the ring gear 46 rotates the primary gear 50, and the primary gear 50 rotates the secondary gear 58 and the first bevel gear 64. The first bevel gear 64 drives the second bevel gear 66, the shaft 68, and worm gear 72, and the worm gear 72 in turn rotates the crank gear 80. As the crank gear 80 rotates, and the pin 106 is at an end of the slot 108, the connecting arm 102 drives the piston 94 to move down in the piston sleeve 88. As the piston 94 moves down, air is drawn into the sleeve 88 from the atmosphere through the filter 146, the cavity 150, the intake hose 116, and the intake valve 112. Once the piston 94 has reached the bottom of its stroke, the piston 94 is then forced upwardly by the spring 92. The spring 92 is allowed to force the piston 94 upwardly because pin 106 is allowed to move in the slot 108, which therefore allows the connecting arm 102 to also move upwardly with the piston 94. As the piston 94 is moved upward by the spring 92, air is forced out of the sleeve 88 and out of the outlet valve 114 into the cavity 16. Once there is a desired amount of pressure in the tire 18, the air pressure applies a force to the plunger 166, overcoming the force of the spring 170 to move the plunger 166 into the large diameter portion 162 of the aperture 160, and therefore causing the shaft 168 to extend into the casing 20, best seen in FIG. 15B.

Once the shaft 168 extends into the casing 20 as shown in FIG. 15B, the winding wheel 26 no longer rotates because the winding wheel 26 comes into contact with the shaft 168, which prevents the winding wheel 26 from rotating. This in turn prevents rotation of the sun gear 40, the planetary gears 42, the ring gear 46, primary gear 50, secondary gear 58, first bevel gear 64, second bevel gear 66, worm gear 72, and crank gear 80. The prevention of the rotation of the various gears also prevents the piston 94 from moving in the sleeve 88, which in turn prevents any air from being pumped into the tire 18.

Over time, if the tire 18 loses pressure due to temperature changes, permeability in the tire, or a slow puncture leak develops, the reduced pressure allows the spring 170 to force the plunger 166 out of the large diameter portion 162 and into the inner recess 180 as described above, and retracts the shaft 168 into the small diameter portion 164, which allows the winding wheel 26 to rotate as the tire 18 rotates. The piston 94 forces air into the cavity 16 as described above until the tire 18 has the desired amount of pressure. Once the desired amount of pressure is reached in the cavity 16 of the tire 18, the air pressure applying force to the plunger 166 to overcome the force of the spring 170 moves the plunger 166 back into the large diameter portion 162, extending the shaft 168 into the casing 20, preventing the rotation of the winding wheel 26, as described above.

The overall mechanical advantage from the winding wheel 26 to the piston 94 is enough to move the piston 94 and overcome the force applied to the piston 94 by the spring 92. Different winding wheels 26 of different weights may be used, and the heavier the winding wheel 26, the less of a mechanical advantage is needed. Additionally, the size of the piston spring 92 is based on the diameter of the piston 94; the larger the piston 94, the heavier the spring 92 must be to move the piston 94. The piston 94, spring 92, and winding wheel 26 of pump 10 may be sized to make the pump suitable for use with virtually any size tire, and the regulator valve 156 may be replaced with other regulator valves to set a specific pressure required for a certain tire. A larger tire may require a longer amount of time to inflate compared to a smaller tire, but the pump 10 would still perform sufficiently regardless of the size of the tire. This allows the pump 10 of the present invention to be used with virtually any size tire, regardless of the amount of pressure needed for proper inflation.

The pump 10 of the present invention is self-actuating, and only increases the pressure in the tire 18 when necessary. The pump 10 is also suitable for use with a tire pressure sensor, an electromechanical regulator could then be used instead of the regulator valve 156. While the present invention has been described using a winding wheel 26, other devices may be used to harness the energy of the rotating tire 18, such as, but not limited to, fan blades, a venturi, a pendulum, as well as an electromechanical device. Furthermore, while the pump 10 has been shown with the spring loaded piston pump assembly 86, other types of pumping devices may be used as well, such as, but not limited to, a diaphragm pump, a turbine, centrifugal pumps, rotary pumps, peristaltic pumps, or an electromechanical pump.

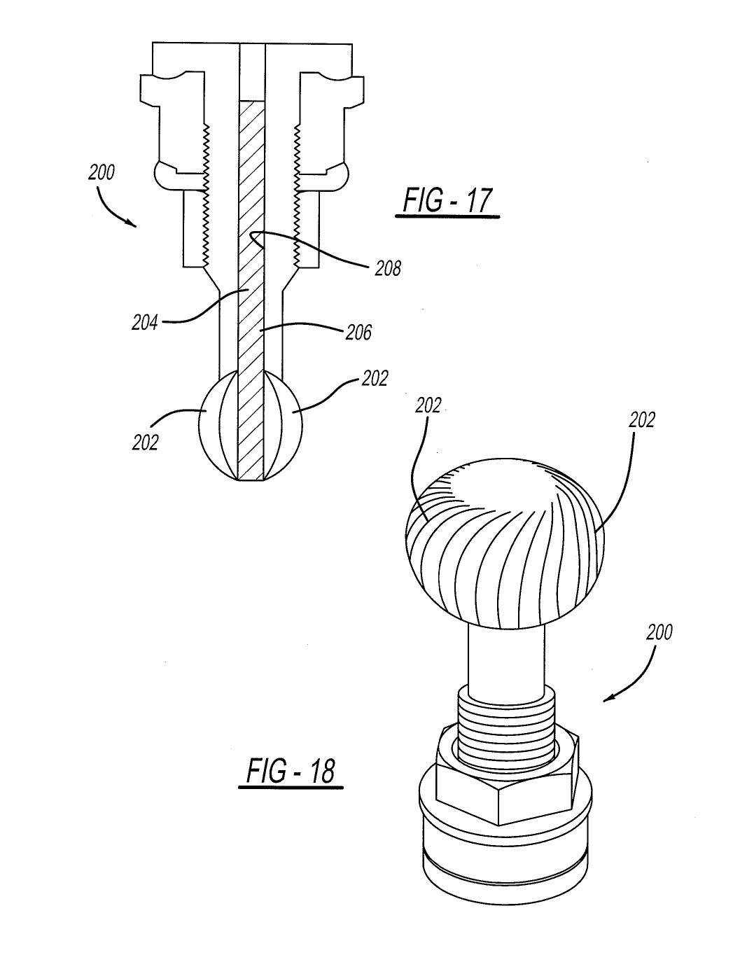

For example, in FIGS. 17 and 18, two alternate embodiments of a rotary screw pump, are shown generally at 200. Each screw pump 200 includes a set of rotary fan blades 202 connected to a shaft 204 having a helical outer surface 206. The shaft 204 is disposed in a bore 208, and the bore 208 is in fluid communication with the inside of a tire. As the fan blades 202 and shaft 204 rotate, air is forced by the fan blades 202 into the bore 208 along the helical outer surface 206 of the shaft 204, and into the tire, increasing the tire pressure.

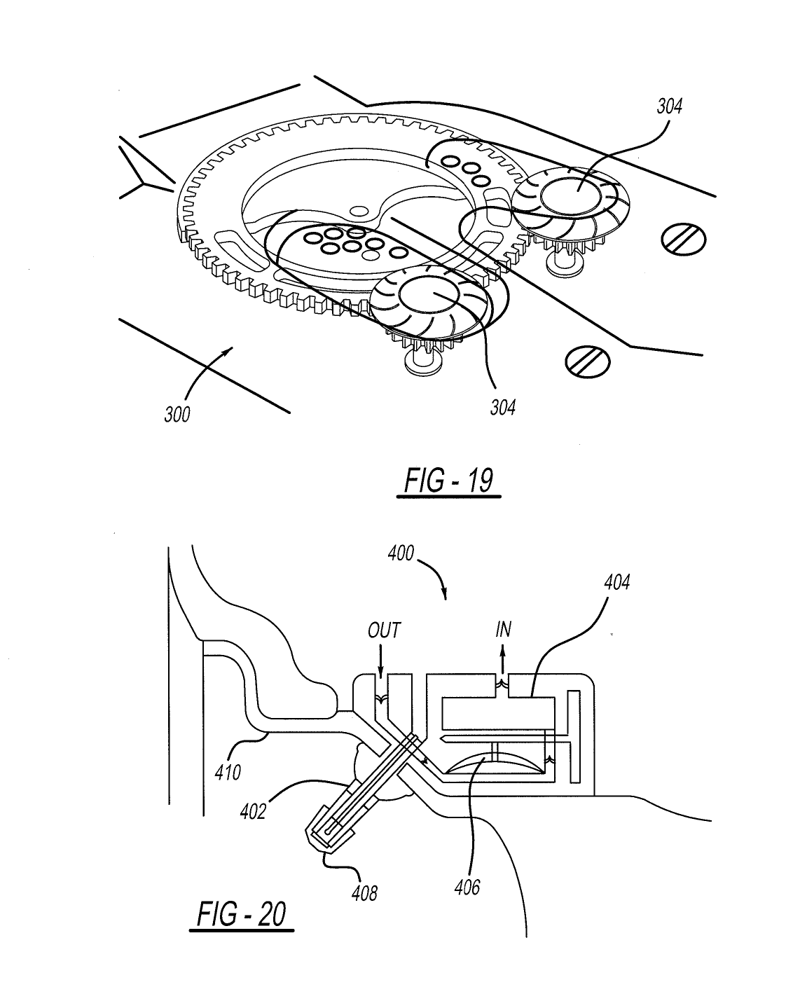

Referring to FIG. 19, an alternate embodiment of a pump 300 is shown having a winding wheel 302 which spins a pair of turbines 304 for compressing air stored in small air tanks. FIG. 20 shows a diaphragm pump, shown generally at 400, having a diaphragm pumping device 406 in which clean air is pulled through a filter 402, located in proximity to a valve 408 and rim 410, and stored in a tank 404 until an open valve calls for the stored air.

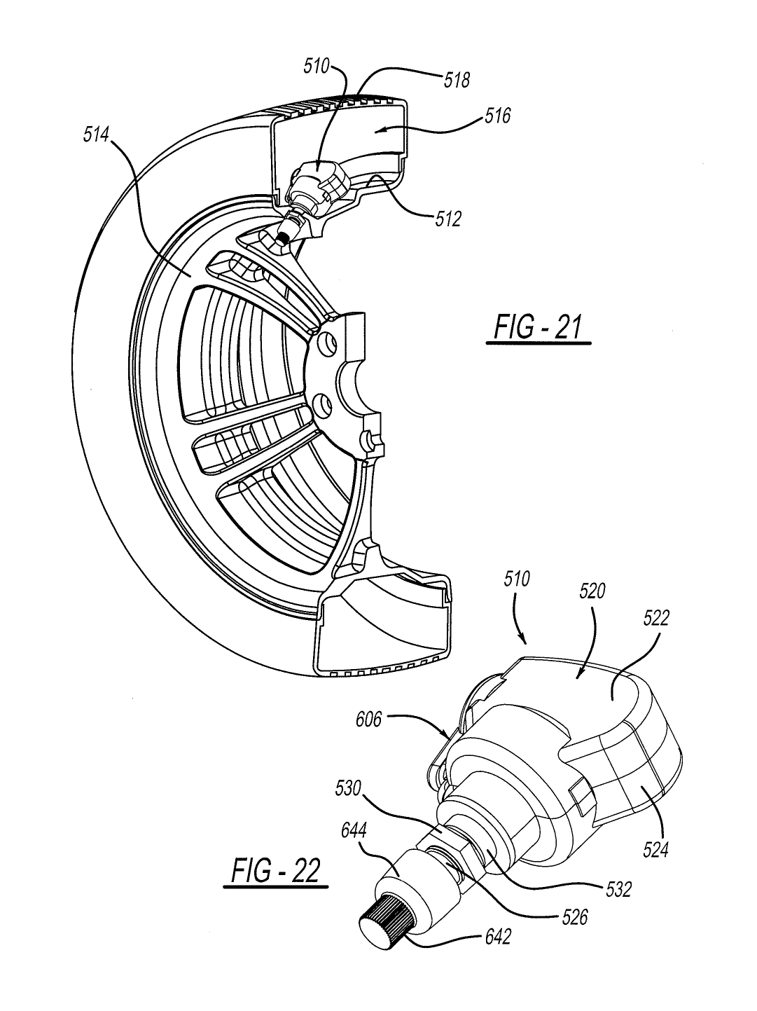

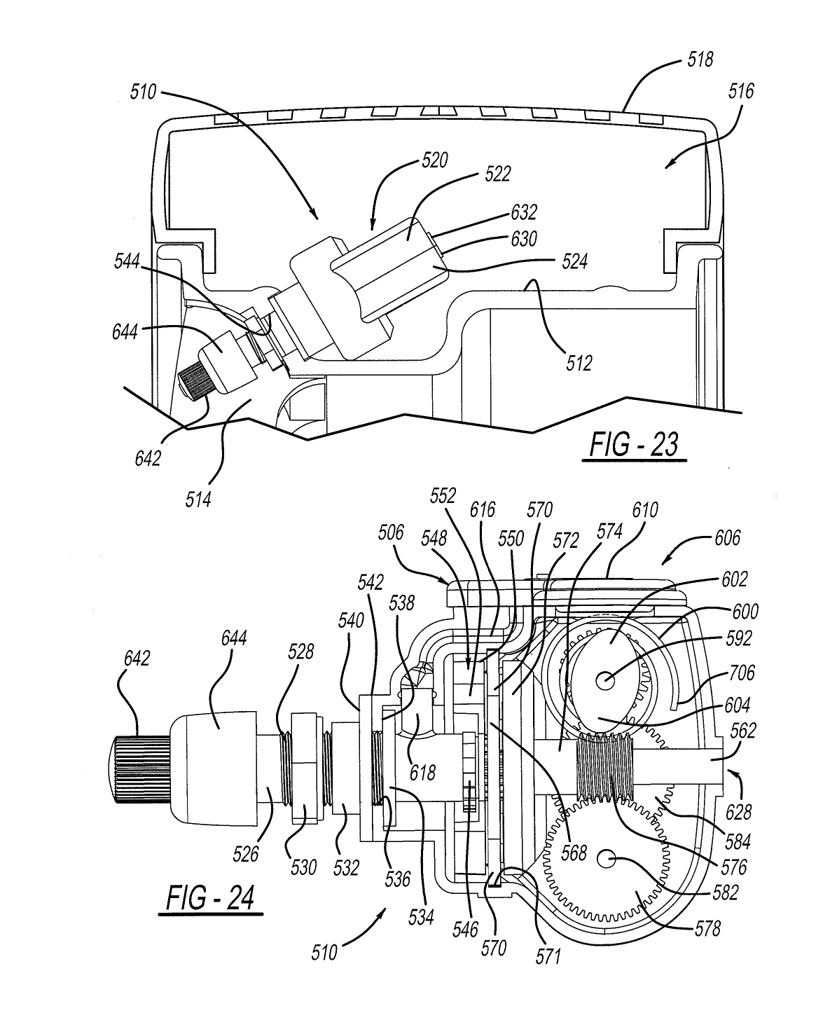

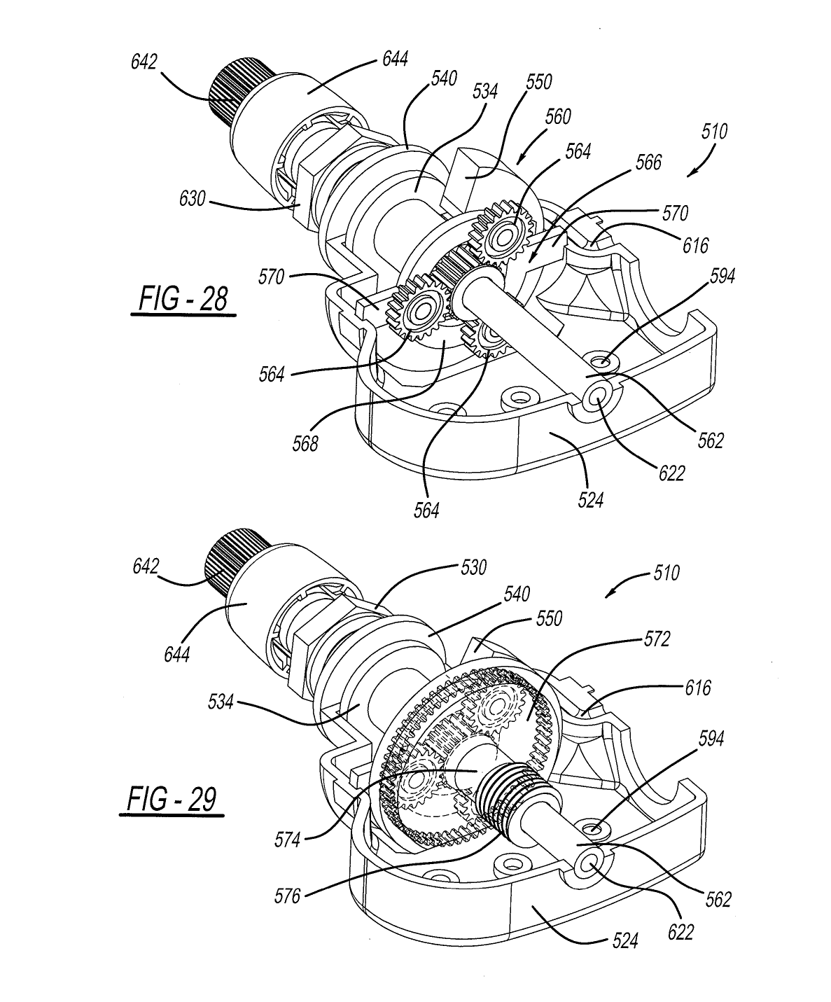

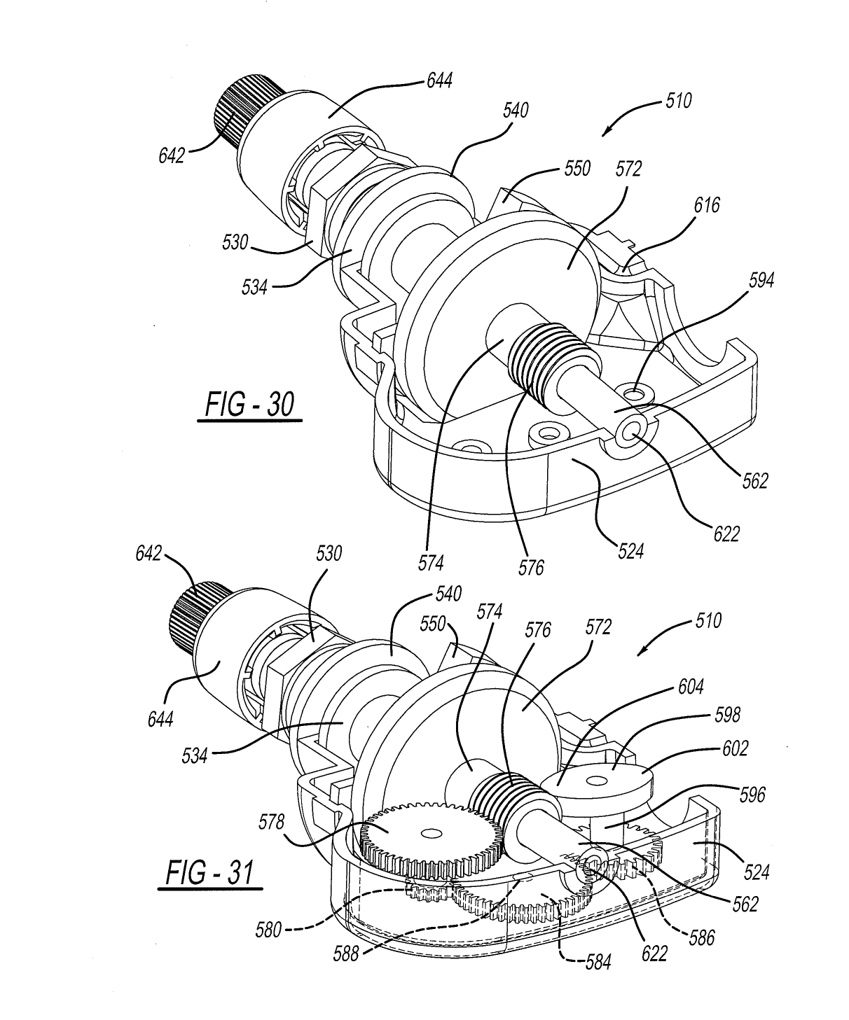

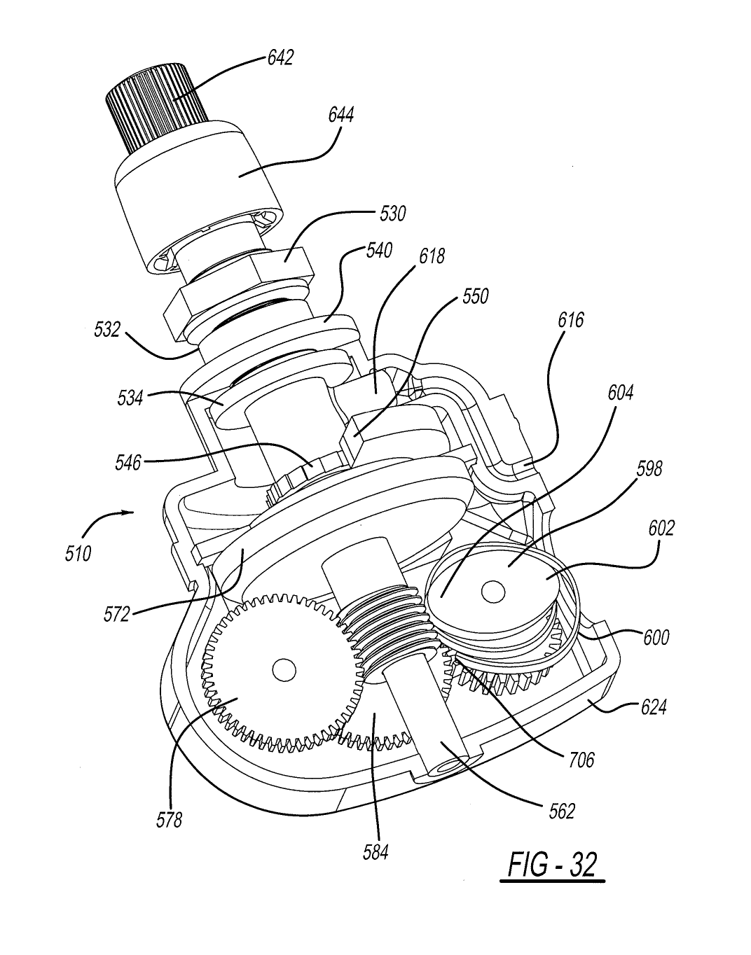

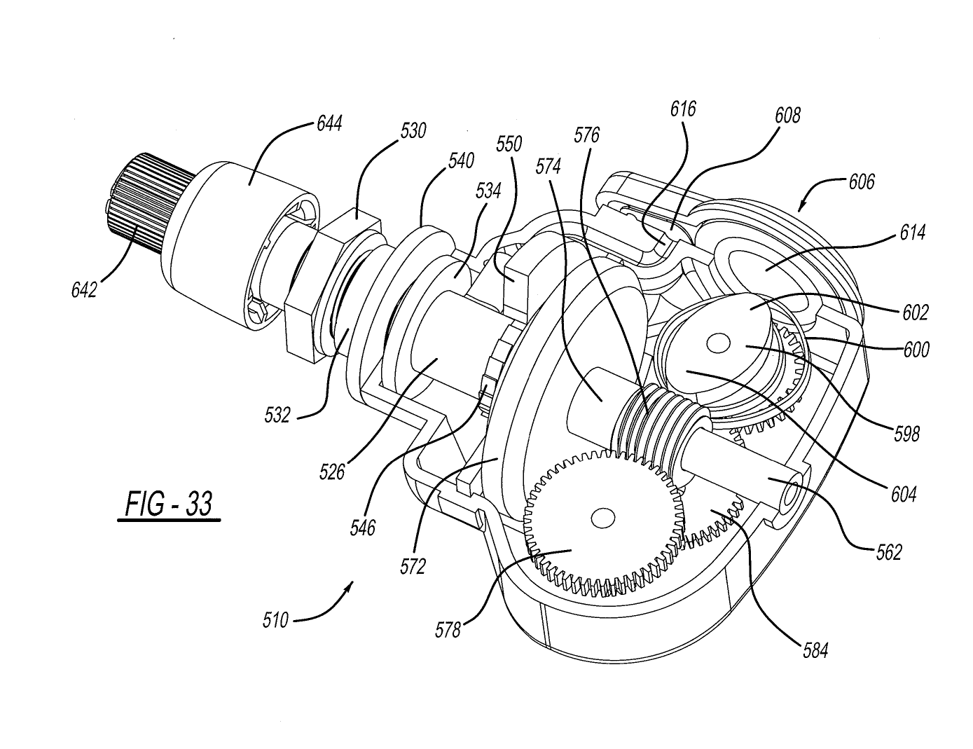

Another embodiment of the invention is shown in FIGS. 21-35. Referring to FIGS. 21-35 generally, an embodiment of a pump assembly or micro-pump according to the present invention is shown generally at 510. The pump 510 is mounted to the outer radius 512 of a rim 514, and is located inside a cavity, generally shown at 516, formed by the rim 514 and a tire 518. The pump 510 may be used in place of a typical tire valve, without requiring any modification to the rim 514.

The pump 510 has a body portion or casing, shown generally at 520, which has various apertures and contours to accommodate the various parts of the pump 510. The casing 520 has an upper half 522 and a lower half 524, the upper half 522 has been removed to reveal the various components of the pump 510. Partially disposed in the casing 520 is a main air tube 526, which has a threaded portion 528. Disposed on the threaded portion is a nut 530 and a gasket 532. Adjacent the threaded portion 528 and also formed as part of the main air tube 526 is a flange 534, the threaded portion 528 extending into an aperture 536 formed by the halves 522,524 of the casing 520 when the casing 520 is assembled. The flange 534 is adjacent an inner surface 538 of the casing 520, and a flange 540 formed as part of the gasket 532 is adjacent an outer surface 542 of the casing 520, best seen in FIGS. 24-26.

The gasket 532 extends into an aperture 544 formed as part of the rim 514. The nut 530 placed on the threaded portion 528 such that the rim 514 is between the nut 530 and the gasket 532, securing the pump 510 to the rim 514.

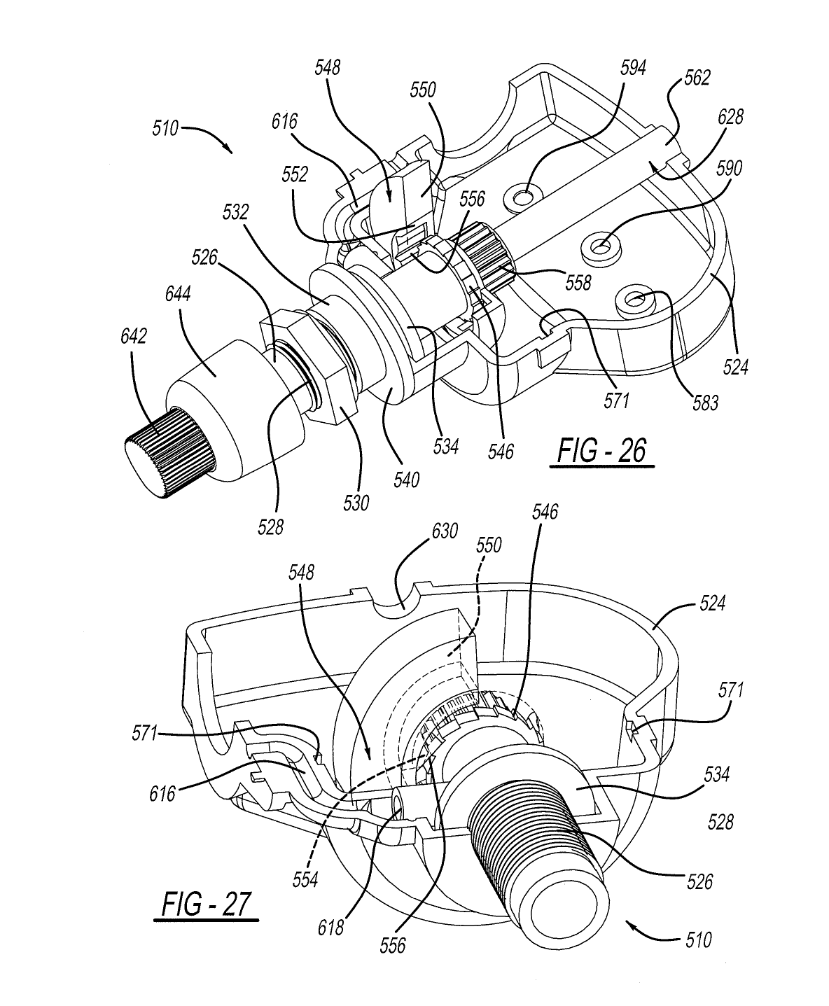

Formed as part of the main air tube 526 is a plurality of stepped features 546. At least partially surrounding the plurality of stepped features 546 is an off-balance winding wheel, shown generally at 548, the off-balance winding wheel 548 has a body portion 550 mounted to a hub 552. The hub 552 has a slot 554 which receives a portion of a flange 556, and the flange 556 extends away from the hub 552 as shown in FIGS. 26 and 27 to selectively contact one of the stepped features 546. In this embodiment, the stepped features 546 and flange 556 provide a “ratchet function” which allows the wheel 548 to rotate around the main air tube 526 in one direction, and prevents rotation of the wheel 548 in the opposite direction. However, it is within the scope of the invention that the wheel 548 may be allowed to rotate in any direction, the function of which will be described later.

The hub 552 is part of a primary gear set. The primary gear set also includes a sun gear 558, and the hub 552 is integrally formed with the sun gear 558. The sun gear 558 is part of a planetary gear set, shown generally at 560. The sun gear 558 surrounds, but is able to rotate relative to a fill air tube 562. The planetary gear set 560 also has three planetary gears 564 which are in mesh with the sun gear 558. The planetary gears 564 are rotatably mounted on a carrier, shown generally at 566. The carrier 566 has a circular portion 568 upon which the planetary gears 564 are rotatably mounted, and has two flanges 570 extending away from the circular portion 568 in opposite directions. The flanges 570 each partially extend into respective recesses 571 formed as part each half 522,524 of the casing 520, securing the carrier 566 relative to the casing 520 when the pump 510 is assembled.

Surrounding and in mesh with the planetary gears 564 is a ring gear 572; the ring gear 572 has internal teeth which are in mesh with the planetary gears 564. In addition to the hub 552 and sun gear 558, the planetary gear set 560 and ring gear 572 are also part of the primary gear set.

The ring gear 572 is also integrally formed with a tube portion 574, and the tube portion 574 is integrally formed with a worm gear 576. The tube portion 574 and worm gear 576 are hollow, and the fill air tube 562 extends through the tube portion 574 and worm gear 576. The tube portion 574 and worm gear 576 are in a non-contacting relationship with and are able to rotate relative to the fill air tube 562, the function of which will be described later. The worm gear 576 is in mesh with a secondary gear 578, and integrally formed with the secondary gear 578 is a pinion gear 580. The secondary gear 578 and pinion gear 580 are rotatably mounted on a shaft 582 mounted in an aperture 83 formed as part of the lower half 524 of the casing 520. The worm gear 576, secondary gear 578, and pinion gear 580 are part of a secondary gear set.

The pinion gear 580 is in mesh with a first intermediate gear 584, and the intermediate gear 584 is in mesh with a second intermediate gear 586. The intermediate gears 584,586 are also part of the secondary gear set.

The first intermediate gear 584 is rotatably mounted on a shaft 588 which is at least partially received into an aperture 590, and the second intermediate gear 586 is also rotatably mounted on a shaft 592 which is at least partially received into an aperture 594. The second intermediate gear 586 is integrally formed with a hub portion 596. A cam 598 is also mounted on the shaft 592, but is not connected to the hub portion 596, and therefore is free to rotate relative to the hub portion 596. Surrounding the hub portion 596 is a biasing member in the form of a spring 600. In this embodiment, the spring 600 is a helical spring 600, but it is within the scope of the invention that other types of springs may be used. A first end of the spring 600 is connected of the hub portion 596, and a second end 706 of the spring 600 has a connector portion which is connected to the cam 598 to anchor the second end 706 of the spring 600. The cam 598 is held in place and prevented from rotating through the use of a release mechanism.

The cam 598 is oval in shape, and has a first and a second lobe 604. The lobes 602,604 are selectively in contact with a diaphragm pump, shown generally at 606. The diaphragm pump 606 includes a one-way inlet valve 608, and a one-way outlet valve 610, and both valves 608,610 are in fluid communication with a cavity, shown generally at 612. Each valve 608,110 is substantially similar, and are made up of a flat plate portion which flexes during the operation of the pump 606. The pump 606 also includes a flexible diaphragm 614 which is selectively contacted by the lobes 602,604. Air passes through the inlet valve 608 into the cavity 612 from an inlet passage 616 formed by both the halves 522,524 of the casing 520 when the casing 520 is assembled together. The inlet passage 616 receives a portion of and is in fluid communication with a side tube 618, and the side tube 618 is integrally formed as part of the main air tube 526.

As mentioned above, the fill air tube 562 extends through the tube portion 574 and worm gear 576, and the fill air tube 562 also extends through and is surrounded by the main air tube 526. The main air tube 526 is of a larger diameter compared to the fill air tube 562 such that there is a cavity, shown generally at 620, located between the inner diameter of the main air tube 526 and the outer diameter of the fill air tube 562. Although the fill air tube 562 is hollow and has an inner passage 622, the inner passage 622 and the cavity 620 are separate and are not in fluid communication with one another.

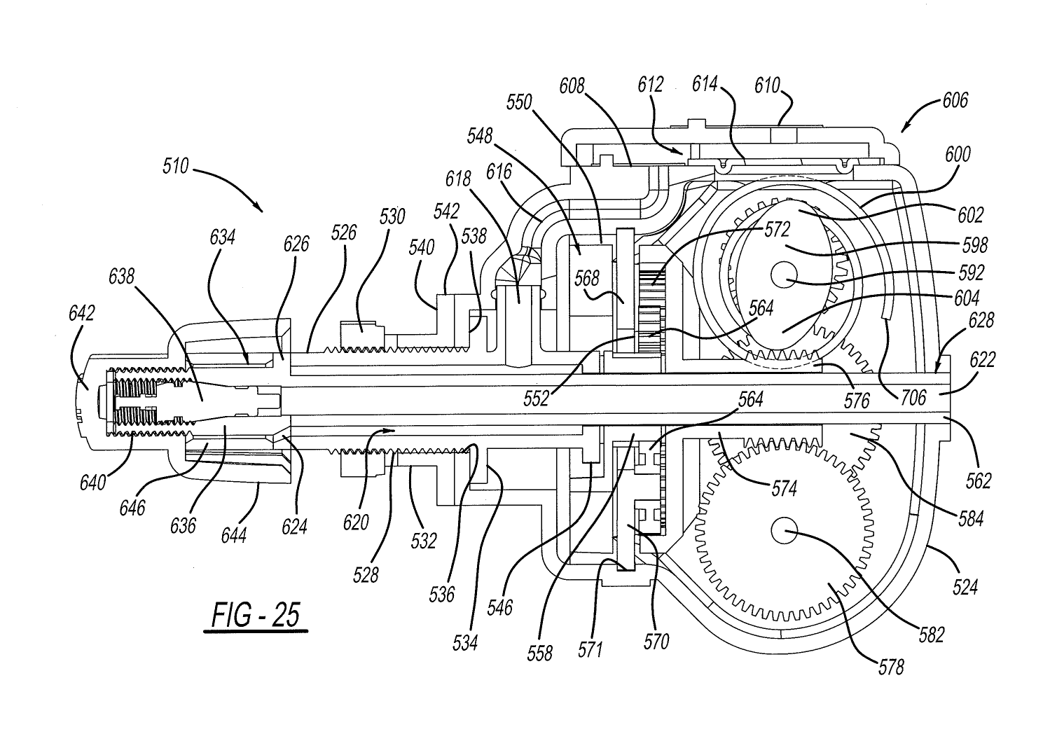

The cavity 620 is instead in fluid communication with an aperture 624 formed as part of a flange portion 626, and the flange portion 626 is integrally formed with the fill air tube 562, best seen in FIG. 25. The fill air tube 562 also includes two end portions, a first end portion shown generally at 628 which is supported by a lower recessed portion 630 formed as part of the lower half 524 of the casing 520, and an upper recessed portion 632 formed as part of the upper half 522 of the casing 520 such that when the casing 520 is assembled, the recessed portions 630,632 support the first end portion 628 such that the fill air tube 562 is in fluid communication with the cavity 516.

The fill air tube 562 also includes a second end portion, shown generally at 634, which not only has the flange portion 626, but also includes a valve stem 636 which receives a check valve 638. The valve stem 636 also has a threaded surface 640 which selectively receives a cap 642. The cap 642 has an enlarged diameter portion 644 which covers a filter 646 located on the second end portion 634, and the filter 646 is substantially adjacent to the flange portion 626. The enlarged diameter portion 644 of the cap 642 is large enough such that there is space between the enlarged diameter portion 644 and the filter 646 to allow air flow underneath the enlarged diameter portion 644 and through the filter 646 and into the cavity 620.

In operation, the micro-pump 510 may be used to change the pressure inside the cavity 516 of the tire 518. The cap 642 is removed and an air hose may be attached to the valve stem 636, and air may be pumped through the check valve 638, the inner passage 622, and into the cavity 516. However, there are times when the tire 518 may lose pressure during vehicle travel, and it may not be possible to attach an air hose to the valve stem 636 because an air hose may not be available. As the tire 518 rotates during vehicle travel, the off-balance winding wheel 548 rotates about the stepped features 546. As the off-balance winding wheel 548 rotates, the sun gear 558 rotates as well, which in turn rotates the planetary gears 564. The rotation of the planetary gears 564 causes the ring gear 572 to rotate as well, which also rotates the worm gear 576. The worm gear 576 rotates the secondary gear 578 and the pinion gear 580, which in turn drives the first intermediate gear 584. The first intermediate gear 584 rotates the second intermediate gear 586 and because the cam 598 is prevented from rotating by the release mechanism, the rotation of the second intermediate gear 586 and hub portion 596 relative to the cam 598 winds up the spring 600.

Once the spring 600 has a desired amount of tension, the cam 598 is released. The cam 598 is then free to rotate relative to the hub portion 596 and the intermediate gear 586. The tension in the spring 600 is allowed to release, causing the rotation of the cam 598. As the cam 598 rotates, the lobes 602,604 selectively press the diaphragm 114. As the diaphragm 614 is pressed by the lobes 702,704, air in the cavity 612 is forced out of the outlet valve 610. When the diaphragm 614 is released, air is drawn into the cavity 612 through the inlet valve 608.

The air drawn into the cavity 620 through the inlet valve 608 is drawn in from the inlet passage 616. The inlet passage 616 is in fluid communication with the side tube 618, and the side tube 618 is formed as part of the main air tube 526. The side tube 618 is also in fluid communication with the cavity 620. The release of the diaphragm 614 causes air to flow underneath the enlarged diameter portion 644 of the cap 642, through the filter 646 such that the air passes through the aperture 624 into the cavity 620. The air then flows through the side tube 618, through the inlet passage 616, and through the inlet valve 608 into the cavity 612. When one of the lobes 602,604 again contacts the diaphragm 714, the diaphragm 614 is pressed and air is forced out of the cavity 612 through the outlet valve 610. The air forced out of the outlet valve 610 is forced into the cavity 516.

Because each of the valves 608,610 are one-way valves, when air is forced out of the cavity 612 as the diaphragm 614 is pressed, the inlet valve 608 remains closed and the outlet valve 610 is open. Conversely, as air is drawn into the cavity 612 when the diaphragm 614 is released, the outlet valve 610 remains closed, and the inlet valve 608 is open.

Once the tension in the spring 600 is fully released, the cam 598 is reengaged with the release mechanism to prevent the cam 598 from rotating. This allows tension to be built up in the spring 600 again, and the cam 598 is then ready to actuate the diaphragm 614 again. The release mechanism is configured to release the cam 598 when a predetermined amount of tension is built up in the spring 600.

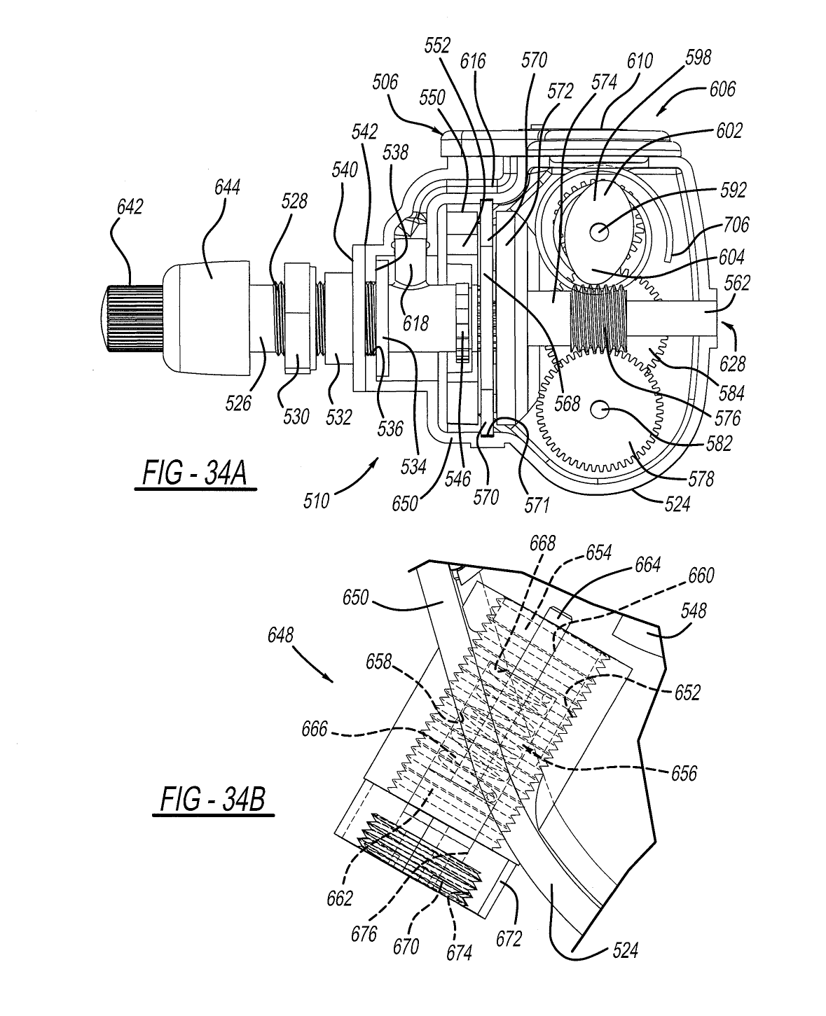

The pumping action by the diaphragm pump 606 acts to inflate the tire 518 without any action required by the driver of the vehicle. Referring now to FIGS. 34A and 34B, a regulator valve, shown generally at 648, is used to regulate the pressure inside the tire 518. Formed in a side wall 650 of the lower half 524 of the casing 520 is a threaded aperture 652 which receives the regulator valve 648. The regulator valve 648 includes a threaded body portion 654 which is received into the threaded aperture 652. The threaded body portion 654 has an aperture, shown generally at 656. The aperture 656 has a large diameter portion 658 and a small diameter portion 660. Slideably disposed within the large diameter portion 658 is a plunger 662, and extending from the plunger 662 is a shaft 664, the shaft 664 extends through both diameter portions 658,660 and out of the small diameter portion 660 into the pump 510 in an area proximate to the winding wheel 548. Also disposed within the large diameter portion 658 is a spring 666 in between the bottom surface 668 of the large diameter portion 658 and the plunger 662. A cap 670 is connected to a mounting block 672 having an outer recess 674 for a least partially receiving the cap 670, and an inner recess 676, which the plunger 662 is operable for slidably extending through.

The regulator valve 648 is exposed to the cavity 516 such that the pressure inside the cavity 516 is applied to the plunger 662 through a hole in the cap 670. If the pressure applied to the plunger 662 is less than the force applied to the plunger 662 from the spring 666, the plunger 662 is moved into the inner recess 676 of the mounting block 672, and the shaft 664 is moved away from the winding wheel 548 and into the small diameter portion 660 of the aperture 656. The winding wheel 548 is then allowed to rotate. As the tire 518 and rim 514 rotate during vehicle travel, the change in position of the tire 518 and rim 514 change the position of the winding wheel 548 such that the winding wheel 548 rotates. As the winding wheel 548 rotates, the sun gear 558 rotates as well, which in turn rotates the planetary gears 564. This in turn rotates the ring gear 572, which also rotates the worm gear 576. The worm gear 576 rotates the secondary gear 578 and the pinion gear 580, which in turn drives the first intermediate gear 584. The first intermediate gear 584 rotates the second intermediate gear 586 and therefore winds up the spring 600, as described above. Once the cam 598 is released, the lobes 602,604 and the diaphragm 614 generate the pumping action as described above to increase the pressure inside the cavity 516.

Once there is a desired amount of pressure in the tire 518, the air pressure applies a force to the plunger 662, overcoming the force of the spring 666 to move the plunger 662 into the large diameter portion 658 of the aperture 656, and therefore causes the shaft 664 to extend into the casing 520, best seen in FIG. 34B.

Once the shaft 664 extends into the casing 520 as shown in FIG. 34B, the winding wheel 548 no longer rotates because the winding wheel 548 comes into contact with the shaft 664, which prevents the winding wheel 548 from rotating. This in turn prevents rotation of the sun gear 558, the planetary gears 564, the ring gear 572, worm gear 576, secondary gear 578, pinion gear 580, the first intermediate gear 584, and the second intermediate gear 586. The prevention of the rotation of the various gears also prevents the winding of the spring 600, and therefore the cam 598 cannot be used to operate the diaphragm pump 606, which in turn prevents any air from being pumped into the tire 518.

Over time, if the tire 518 loses pressure due to temperature changes, permeability in the tire, or a slow puncture leak develops, the reduced pressure allows the spring 666 to force the plunger 662 out of the large diameter portion 658 and into the inner recess 676 as described above, and retracts the shaft 664 into the small diameter portion 660, which allows the winding wheel 548 to rotate as the tire 518 rotates. The diaphragm pump 606 forces air into the cavity 516 as described above until the tire 518 has the desired amount of pressure. Once the desired amount of pressure is reached in the cavity 516 of the tire 518, the air pressure applying force to the plunger 662 to overcome the force of the spring 666 moves the plunger 662 back into the large diameter portion 658, extending the shaft 664 into the casing 520, preventing the rotation of the winding wheel 548, as described above.

The overall mechanical advantage from the winding wheel 548 to the cam 598 is enough to move second intermediate gear 586 and the cam 598 to generate the winding of the spring 600. Different winding wheels 548 of different weights may be used, and the heavier the winding wheel 548, the less of a mechanical advantage is needed. The cam 98, spring 600, diaphragm pump 606, and winding wheel 548 of the pump 510 may be sized to make the pump 510 suitable for use with virtually any size tire, and the regulator valve 648 may be replaced with other regulator valves to set a specific pressure required for a certain tire. A larger tire may require a longer amount of time to inflate compared to a smaller tire, but the pump 510 would still perform sufficiently regardless of the size of the tire. This allows the pump 510 of the present invention to be used with virtually any size tire, regardless of the amount of pressure needed for proper inflation.

The pump 510 of the present invention is self-actuating, and only increases the pressure in the tire 518 when necessary. The pump 510 is also suitable for use with a tire pressure sensor, an electromechanical regulator could then be used instead of the regulator valve 648. While the present invention has been described using a winding wheel 548, other devices may be used to harness the energy of the rotating tire 518, such as, but not limited to, fan blades, a venturi, a pendulum, as well as an electromechanical device. Furthermore, while the pump 510 has been shown with the diaphragm pump 606, other types of pumping devices may be used as well, such as, but not limited to, a piston pump, a turbine, centrifugal pumps, rotary pumps, peristaltic pumps, or an electromechanical pump.

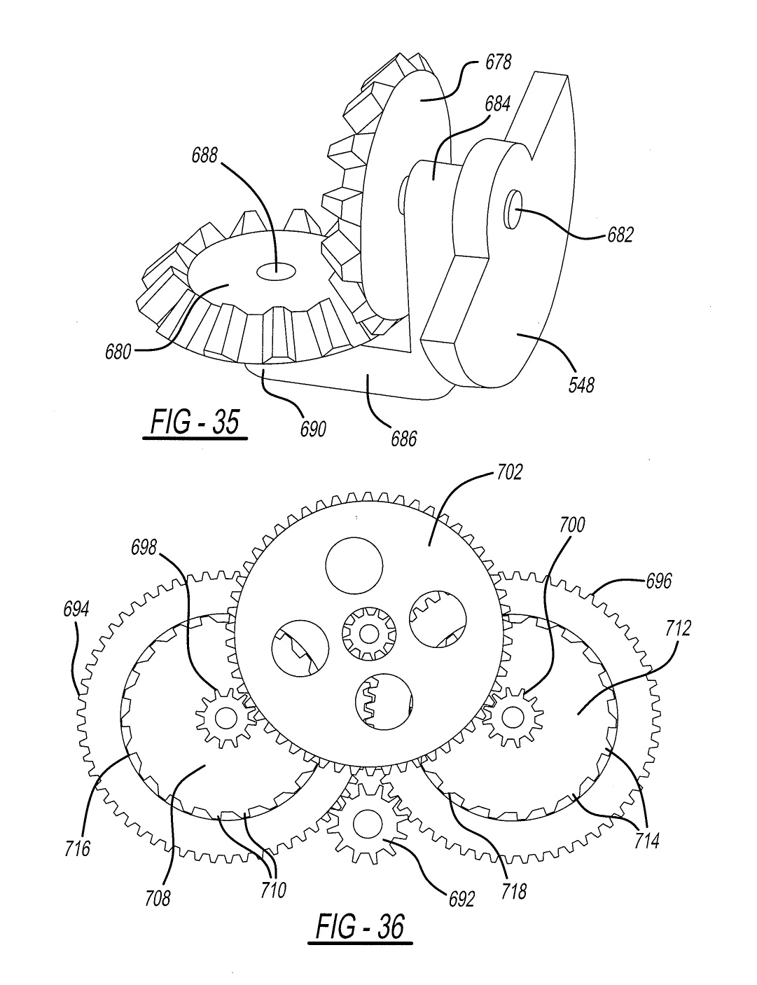

Referring to FIG. 35, an alternate embodiment of gears used with the pump 510 according to the present invention is shown, with many of the components of the pump 510 removed for clarity. More specifically, this embodiment still includes the off-balance winding wheel 548, but the off-balance winding wheel 548 is able to rotate in multiple directions to drive the primary gear set. The winding wheel 548 is attached to a first bevel gear 678, and the first bevel gear 678 is in mesh with a second bevel gear 680 oriented approximately ninety-degrees relative to the first bevel gear 678. The winding wheel 548 shown in FIG. 35 is mounted on a shaft 682 which extends through the first end portion 684 of an L-bracket 686. The first bevel gear 678 is also mounted on the shaft 682, and rotates with the winding wheel 548. The second bevel gear 680 is fixedly mounted on a second shaft 688 which extends through a second end 690 of the L-bracket 686. The shaft 688 and therefore the second bevel gear 680 rotate together, but rotate relative to the L-bracket.

In this embodiment, the second shaft 688 is connected to the sun gear 558, which in turn drives the planetary gears 564 and ring gear 572 in the same manner as previously described, driving the worm gear 576 for rotation to therefore drive the secondary gear 578, the pinion gear 580, the first intermediate gear 584, and the second intermediate gear 586 in a similar manner described in the previous embodiment. The bevel gears 678,680 rotate relative to one another while allowing the wheel 548 to rotate as well. This allows the wheel 548 to rotate about multiple axes, and still drive the primary gear set.

Another embodiment of the invention is shown in FIG. 36. This embodiment is a bi-directional winding mechanism, which includes a master gear 692 which is connected to the winding wheel 548 for generating a rotational force. The master gear 692 is in mesh with a first perimeter gear 694, and the first perimeter gear 694 is in mesh with a second perimeter gear 696. Circumscribed by the first perimeter gear 694 is a first central gear 708 having a first set of sloping teeth 710. A second central gear 712 is circumscribed by the second perimeter gear 696, and the second central gear 712 has a second set of sloping teeth 714. The first perimeter gear 694 has a first set of ratchet pawls 716 which selectively engage the first set of sloping teeth 710. The second perimeter gear 696 has a second set of ratchet pawls 718 which selectively engage the second set of sloping teeth 714. Connected to the first central gear 708 is a first pinion gear 698, which rotates with the first central gear 708. Connected to the second central gear 712 is a second pinion gear 700, which rotates with the second central gear 712. Each of the pinion gears 698,700 is in mesh with an upper gear 702, and the upper gear 702 is in mechanical connection with the sun gear 558.

The casing 520 is of a different shape in this embodiment to accommodate the various components shown in FIG. 36. As the tire 518 rotates during vehicle travel, the winding wheel 548 moves and rotates the master gear 692 in either a clockwise direction or counterclockwise direction. The rotation of the master gear 692 in a clockwise direction rotates the first perimeter gear 694 in a counterclockwise direction, and the first set of ratchet pawls 716 engage the first set of sloping teeth 710 to rotate the first central gear 708 and first pinion gear 698 in a counterclockwise direction, which in turn rotates the upper gear 702 in a clockwise direction. At this time the second perimeter gear 696 does not rotate the second central gear 712 and the second pinion gear 700, because the second set of ratchet pawls 718 do not engage the second set of sloping teeth 714 when the second perimeter gear 696 rotates in a clockwise direction.

When the wheel 548 rotates the master gear 692 in the counterclockwise direction, the first perimeter gear 694 rotates in a clockwise direction, and the second perimeter gear 696 rotates in a counterclockwise direction. When the first perimeter gear 694 rotates clockwise, the first perimeter gear 694 does not rotate the first central gear 708 because the first set of ratchet pawls 716 do not engage the first set of sloping teeth 710. The rotation of the second perimeter gear 696 in a counterclockwise direction causes the second central gear 712 and the second pinion gear 700 to rotate in a counterclockwise direction because the second set of ratchet pawls 718 engage the second set sloping teeth 714. Rotation of the second pinion gear 700 counterclockwise causes the upper gear 702 to rotate clockwise.

In this embodiment, the upper gear 702 rotates in a clockwise direction whether the master gear 692 rotates clockwise or counterclockwise. The upper gear 702 is connected to the sun gear 558, and drives the sun gear 558 for rotation to therefore drive the planetary gears 564, the ring gear 572, the worm gear 576, secondary gear 578, the pinion gear 580, the first intermediate gear 584, and the second intermediate gear 586 in a similar manner described in the previous embodiment.

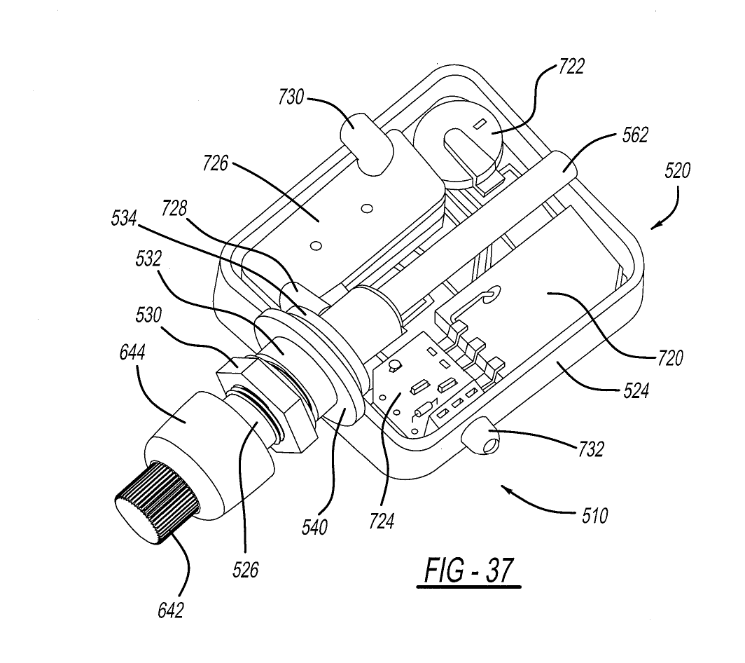

Another embodiment of the present invention is shown in FIG. 37, with like numbers referring to like elements. In this embodiment, the pump 510 uses electronic actuation to create a pumping action. The pump 510 in FIG. 37 is still capable of filling the tire 518 with air by removing the cap 642 and using the fill air tube 562 as described in the previous embodiments. The embodiment in FIG. 37 also includes a piezo device 720 which is in electrical communication with a battery 722. The piezo device 720 charges the battery 722 as the piezo device 720 vibrates during the rotation of the tire 518 during vehicle travel. The piezo device 720 is also in electrical communication with a switch 724, which in this embodiment is an on/off switch 724 which functions to activate the piezo device 720. The battery 722 provides power to an electronic pump 726. Inside the electronic pump 726 is a valve set which is used to pump the air. The electronic pump 726 has an inlet passage 728 in fluid communication with the main air tube 726, and an outlet passage 730 in fluid communication with the cavity 516. The pump 510 shown in FIG. 37 also includes a pressure regulator, but in this embodiment the pressure regulator is an electronic pressure regulator 732.

In operation, when the pressure regulator 732 detects that the pressure in the tire 518 is lower than a predetermined value, the switch 724 activates the piezo device 720, and as the piezo device 720 vibrates, energy is transferred to and optionally stored by the battery 722. The battery 722 also supplies energy to the pump 726, thereby actuating the pump 726 to pump air into the cavity 516 of the tire 518. The air flows underneath the enlarged diameter portion 644 of the cap 642, through the filter 646 such that the air passes through the aperture 624 into the cavity 620. The air then flows through the side tube 618, through the inlet passage 728 and into the pump 726. The pump 726 then forces the air into the cavity 516.

The various embodiments of the pump 10,510 described above function to replace the lost air in the tire 18,518 due to permeability, temperature changes, or slow leak. Each of the embodiments of the pump 10,518 accomplishes this by achieving several steps.

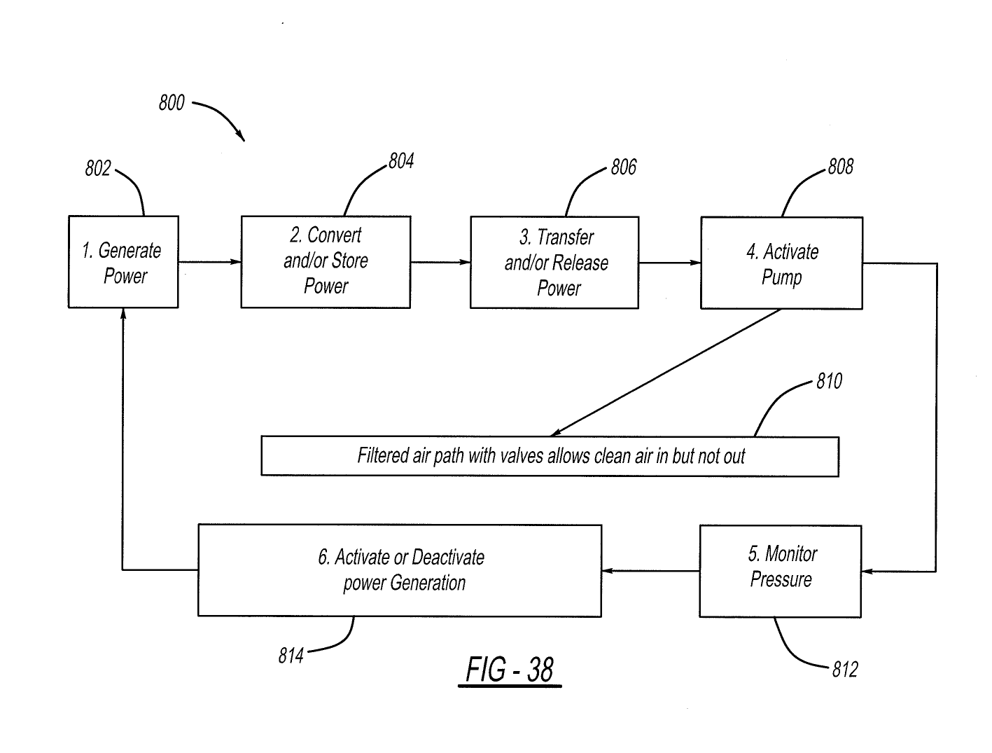

Referring to the Figures generally, and in particular to FIG. 38, there is illustrated a process for maintaining a desired amount of tire pressure in a vehicle tire, shown generally at 800. The first step 802 is that the pump 510 generates power. Generating power may involve capturing kinetic energy, centrifugal forces, air movement, pressure changes, or temperature changes. The present invention accomplishes this through the use of the off-balance winding wheel 548 or the off-balance winding wheel 548 in combination with the bevel gears 678,680. Power may also be generated by capturing the energy of the tire 518 using devices such as, but not limited to, fan blades, a venturi, a pendulum, a spring, a lever, an impeller, a bi-metal spring, a pressure transducer, or a piezioelectric device.

The second step 804 involves converting and if necessary, storing power. The pump 510 of the present invention accomplishes this through the use of the primary gear set, or the combination of the master gear 692, perimeter gears 694,696, pinion gears 698,700, and upper gear 702. The power used by the pump 510 is stored by the winding of the spring 600. However, this power conversion may be accomplished through the use of belts and pulleys, levers, air canisters in the case of pressurized air storage, a generator, a capacitor, a battery, or the like.

The third step 806 involves transferring or releasing power. The pump 510 of the present invention has a release mechanism for releasing the spring 600, driving the rotation of the cam 598. However, stored energy may be released using any one or a combination of a solenoid, a lever, a cam, a circuit board having software, or some type of simple geometry to provide a mechanical release, such as a catch or a slot.

The fourth step 808 is the activation of a pump or the generation of a pumping action, essentially turning stored energy into a pumping action to fill the tire 518 with air. The pump 510 uses the diaphragm pump 606 to pump air into the tire 518, and the cam 598 is used to generate the pumping action of the diaphragm pump 510. However, it is within the scope of the invention that other types of pumps may be used to create a pumping action, such as, but not limited to, the piston pump assembly 10, a turbine pump, a rotary pump, an electro piezo pump, an electro magnet pump, or the like. A filtered air path with valves can be used to allow clean air in but not out, generally shown at 810, if desired.

The fifth step 812 in the process is the monitoring of air pressure in the tire 518, which in the pump 510 of the present invention constantly achieves through the use of the regulator valve 648. Other types of devices may be used to provide constant pressure or intermittent pressure monitoring, such as, but not limited to, pressure transducers, a piezo, a pressure regulator, and the like.

The sixth step 814 in the process is the activation or deactivation of the power generation. This step incorporates the process of monitoring the air pressure, and determining whether the pump 510 is to be activated or deactivated. The pump 510 of the present invention uses the plunger 662, shaft 664, spring 666 of the pressure regulator 648 to accomplish allowing or prohibiting the rotation of the off-balance winding wheel 548, which activates or deactivates the power generation of the winding wheel. This may also be accomplished by a solenoid, a lever, a cam, a circuit board having software, or some type of simple geometry to provide a mechanical release, such as a catch or a slot, or any other device suitable for controlling the activation or deactivation of power generation.

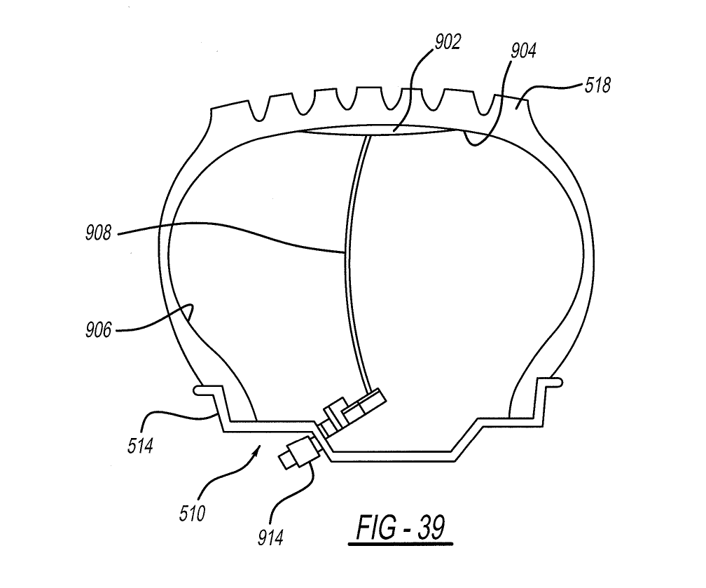

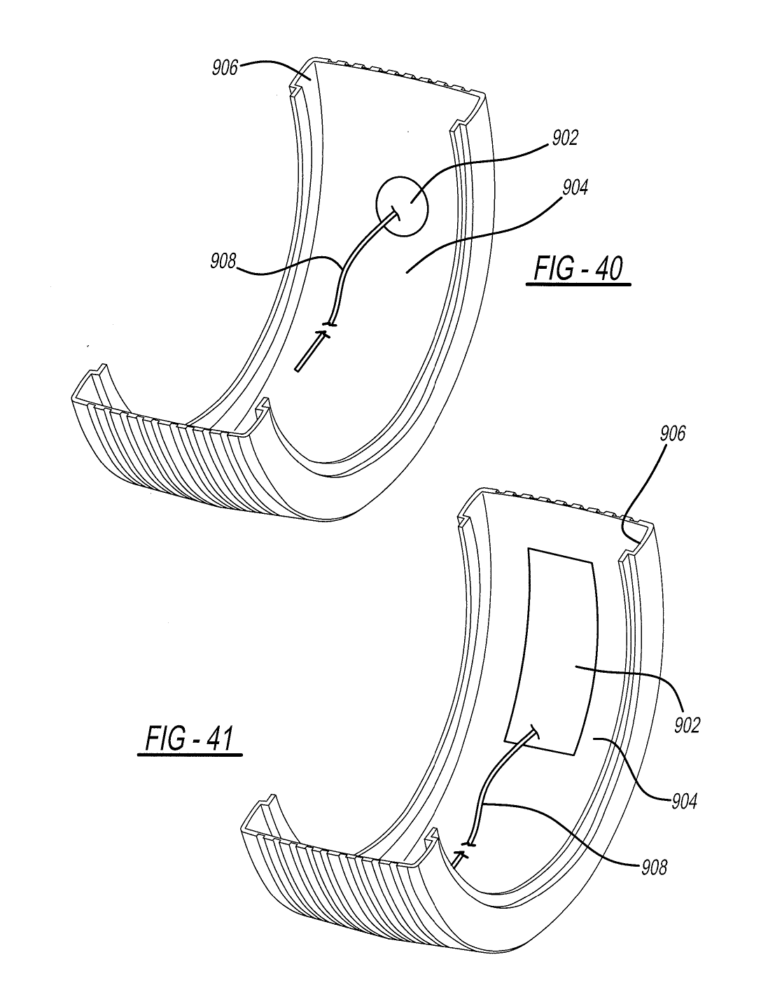

Another embodiment of the present invention is shown in FIGS. 39-41, with like numbers referring to like elements. In this embodiment of the pump assembly 510 a polymer known as “electroactive polymer” for energy harvesting is used to “charge”, providing an electrical based solution. A patch 902 formed of the electroactive polymer material is located on the inside surface 904 of the tire, e.g., inside the cavity 516, or, alternatively, on an inside surface 906 located on the sidewall of the tire, e.g., inside the cavity 516. As the patch 902 material is flexed and/or elongated an electrical charge is created that can be stored and used as needed to run an electronic pump 510. The patch 902 can be in electrical communication with a battery 722 using a power lead 908 to the pump 510 that is mounted to the rim 512 of the tire 518 to transfer the charge during vehicle travel. The battery 722 can provide power to the pump 510. The patch 902 can be generally circular, rectangular, or any other shape operable to flex and/or elongate to create an electrical charge that can be stored and used as needed to maintain a desired amount of tire pressure in the vehicle tire 912. The patch 902 can also be bonded to the tire 518 or, alternatively, the patch 902 can be molded or otherwise integrated into the tire 518.

In an alternative embodiment, a valve stem 914 is over-molded with the electroactive polymer material and allowed (or caused) to flutter in the wind as the vehicle is driven. This motion moves the electroactive polymer to cause an electrical charge to be generated to the pump 510. In operation, as the valve stem 914 flutters, energy is transferred to and optionally stored by a battery 722, which also supplies energy to the pump 510, thereby actuating the pump 510 to pump air into the cavity 516 of the tire 518.

The pump 510 can also include a pressure regulator 724 that detects that the pressure in the tire 518 is lower than a predetermined value and as the electroactive polymer patch 902 creates an electric charge or the valve stem 914 with electroactive polymer over-mold flutters, energy is transferred to and optionally stored by the battery.

In another alternate embodiment, other types of pumps may be used with the electroactive polymer material. Other types of pumps which may be used include, but are not limited to, diaphragm pumps, piston pumps, turbine pumps, centrifugal pumps, rotary pumps, peristaltic pumps, or electromechanical pumps.

The description of the invention is merely exemplary in nature and, thus, variations that do not depart from the essence of the invention are intended to be within the scope of the invention. Such variations are not to be regarded as a departure from the spirit and scope of the invention.

What is claimed is:

1. A micro-pump for use with a vehicle tire, comprising:
a pump assembly; and
a tire connected to a vehicle;
wherein said pump assembly generates a pumping action as said tire rotates such that said pump assembly is operable to inject air into said tire.

2. The micro-pump of claim 1, said pump assembly further comprising:
a casing;
an off-balance winding wheel disposed in said casing;
a primary gear set driven by said off-balance winding wheel, said primary gear set located in said casing;
a secondary gear set driven by said primary gear set, said secondary gear set located in said casing; and
said pump assembly being connected to said casing such that said pump assembly is actuated by said secondary gear set.

3. The micro-pump of claim 1, wherein said pump assembly maintains a predetermined pressure in said tire as said tire rotates.

4. The micro-pump of claim 2, said primary gear set further comprising:
a sun gear connected to said off-balance winding wheel;
at least one planetary gear in mesh with said sun gear; and
a ring gear in mesh with said at least one planetary gear, said ring gear connected to said secondary gear set such that as said off-balance winding wheel rotates, said sun gear rotates said at least one planetary gear, said at least one planetary gear rotates said ring gear, and said ring gear drives said secondary gear set.

5. The micro-pump of claim 4, said secondary gear set further comprising:
a worm gear connected to said ring gear;
a secondary gear in mesh with said worm gear;
a pinion gear connected to and rotatable with said secondary gear;
a first intermediate gear in mesh with said pinion gear, said first intermediate gear having a toothless section; and
a second intermediate gear in mesh with said first intermediate gear;
wherein said worm gear rotates said secondary gear and said pinion gear, said pinion gear drives said first intermediate gear, said and said first intermediate gear drives said second intermediate gear as said ring gear drives said worm gear.

6. The micro-pump of claim 5, further comprising:
a hub portion connected to said second intermediate gear;
a cam connected to said hub portion; and
a spring connected to said hub portion and at least a portion of said casing such that as said second intermediate gear is rotated in a first direction by said first intermediate gear, tension builds in said spring;
wherein said cam, said hub portion, and said second intermediate gear rotate in a second direction when said second intermediate gear is exposed to said toothless section of said first intermediate gear, and said tension in said spring is released.

7. The micro-pump of claim 2, further comprising a regulator valve operable for controlling the amount of pressure in said tire.

8. The micro-pump of claim 2, further comprising:
an inlet passage in fluid communication with said pump assembly;
a side tube in fluid communication with said inlet passage;
a main air tube, said side tube integrally formed as part of said main air tube;
a fill air tube surrounded by said main air tube such that a cavity is disposed between said fill air tube and said main air tube;
a flange portion integrally formed with said fill air tube;
an aperture integrally formed as part of said flange portion;
a filter mounted to said fill air tube such that said filter is adjacent said flange portion;
a valve stem formed as part of said fill air tube;
a cap selectively connected to said valve stem; and
an enlarged diameter portion formed as part of said cap, said enlarged diameter portion surrounds at least a portion of said filter;
wherein as said pump assembly forces air into said tire, air passes through said filter and is drawn in to said cavity through said aperture formed as part of said flange, and flows from said cavity through said side tube, said inlet passage, and into said pump assembly.

9. The micro-pump of claim 2, said pump assembly being a diaphragm pump that is actuated by said secondary gear set.

10. The micro-pump of claim 2, said pump assembly being a piston pump that is actuated by said secondary gear set such that as said off-balance winding wheel rotates, said off-balance winding wheel drives said primary gear set, and said primary gear set drives said secondary gear set, driving said piston pump and increasing the air pressure in said tire.

11. The micro-pump of claim 2, said primary gear set further comprising:
a sun gear connected to said off-balance winding wheel;
a plurality of planetary gears in mesh with said sun gear, said plurality of planetary gears mounted on a carrier, said carrier connected to said casing;
a ring gear in mesh with said plurality of planetary gears such that said ring gear is driven for rotation by said plurality of planetary gears; and
a primary gear mounted to and driven by said ring gear, said primary gear operable for driving said secondary gear set;
wherein said sun gear is driven by said off-balance winding wheel such that said sun gear transfers rotational force to said plurality of planetary gears, and said plurality of planetary gears transfer rotational force to said ring gear and said primary gear, and said primary gear drives said secondary gear set.

12. The micro-pump of claim 2, said secondary gear set further comprising:
a secondary gear driven for rotation by said primary gear set;
a first bevel gear connected to and driven by said secondary gear;
a second bevel gear in mesh with said first bevel gear;
a worm gear connected to and driven by said second bevel gear; and
a crank gear, said crank gear in mesh with said worm gear, and said crank gear operable for actuating said pump assembly;
wherein as said secondary gear is driven by said primary gear set, said first bevel gear rotates and transfers rotational force to said second bevel gear and said worm gear, and said worm gear drives said crank gear, actuating said pump assembly.

13. The micro-pump of claim 2, said off-balance winding wheel further comprising:
a recessed portion operable for receiving a circular protrusion formed as part of a lower half of said casing;
an inner wall formed as part of said recessed portion;
a slot formed as part of said inner wall; and
a flange disposed in said slot formed as part of said inner wall, said flange selectively contacts one of a plurality of stepped features formed as part of said circular protrusion such that as said off-balance winding wheel rotates, said flange is moved from one of said plurality of stepped features to another of said plurality of stepped features, limiting the rotation of said off-balance winding wheel to one direction.

14. The micro-pump of claim 2, said pump assembly further comprising:
a piston sleeve having a bottom surface;
a piston slidably disposed in said piston sleeve;
a connecting arm connected to said piston and said secondary gear set such that as said secondary gear set drives said connecting arm, said piston is moved in said piston sleeve toward said bottom surface; and
a spring connected to a said piston, said spring disposed in said piston sleeve between said piston and said bottom surface to bias said piston away from said bottom surface.

15. The micro-pump of claim 14, said pump assembly further comprising:
a manifold housing connected to said piston sleeve;
an intake valve mounted in said manifold housing, said intake valve is open as said piston moves toward said bottom surface of said piston sleeve, and said intake valve is closed as said piston moves away from the bottom surface of said piston sleeve; and
an outlet valve which is open when said piston moves away from said bottom surface of said piston, and said outlet valve is closed as said piston moves towards said bottom surface of said piston sleeve.

16. The micro-pump of claim 1, further comprising a regulator valve for actuating and de-actuating said micro-pump.

17. The micro-pump of claim 16, said regulator valve further comprising:
a threaded body portion received into a threaded aperture of said casing;
an aperture formed as part of said threaded body portion;
a large diameter portion formed as part of said aperture;
a small diameter portion formed as part of said aperture;
a plunger slidably disposed in said large diameter portion of said aperture;
a shaft connected to said plunger and extending from said plunger in said large diameter portion of said aperture through said small diameter portion of said aperture and selectively extending into said casing in an area in proximity to an off-balance winding wheel;
a spring disposed in said large diameter portion of said aperture and in contact with said plunger;
a mounting block connected to said threaded body portion;
a cap connected to said mounting block;
an outer recess formed as part of said mounting block, said cap being located in said outer recess; and
an inner recess formed as part of said mounting block, said inner recess being in substantial alignment with said large diameter portion formed as part of said aperture, such that an aperture formed as part of said cap allows air into said inner recess to apply pressure to said plunger;
wherein said plunger is disposed in said large diameter portion of said aperture and said shaft is disposed in said casing proximity to said off-balance winding wheel such that said off-balance winding wheel contacts said shaft and is prohibited from rotating when a desired amount of air pressure is in said tire, and when a reduced amount of air pressure is in said tire, said spring moves said plunger and said shaft such that said plunger at least partially moves into said large diameter portion of said aperture, and said shaft is substantially removed from said casing, allowing said off-balance winding wheel to rotate, actuating a primary gear set, a secondary gear set, and said pump assembly, to increase the pressure in said tire.

18. A micro-pump for maintaining a desired amount of pressure in a vehicle, comprising:
a pump assembly;
a tire connected to a vehicle;
an electronic pump for pumping air into said tire, said electronic pump being part of said pump assembly; and
an electronic pressure regulator for monitoring the amount of air pressure in said tire, said electronic pressure regulator being part of said pump assembly;
wherein said pump assembly generates a pumping action when said electronic pressure regulator detects said air pressure in said tire is below a predetermined value.

19. The micro-pump for maintaining a desired amount of pressure in a vehicle of claim 18, said pump assembly further comprising:
a piezo device operable for generating energy;
a battery in electrical communication with said piezo device, such that said piezo device generates energy to be stored by said battery;
a switch in electrical communication with said piezo device such that said switch controls the activation and deactivation of said piezo device; and
an electronic pump in electrical communication with said battery such that when said electronic pump receives energy from said battery, said electronic pump is operable to pump air into said tire.

20. The micro-pump for maintaining a desired amount of pressure in a vehicle of claim 18, further comprising:
an inlet passage in fluid communication with said electronic pump;
a side tube in fluid communication with said inlet passage;
a main air tube, said side tube integrally formed as part of said main air tube;
a fill air tube surrounded by said main air tube such that a cavity is disposed between said fill air tube and said main air tube;
a flange portion integrally formed with said fill air tube;
an aperture integrally formed as part of said flange portion;
a filter mounted to said fill air tube such that said filter is adjacent said flange portion;
a valve stem formed as part of said fill air tube;
a cap selectively connected to said valve stem; and
an enlarged diameter portion formed as part of said cap, said enlarged diameter portion surrounds at least a portion of said filter;
wherein as said electronic pump forces air into said tire, air passes through said filter and is drawn into said cavity through said aperture formed as part of said flange, and flows from said cavity through said side tube, said inlet passage, and into said electronic pump.

21. The micro-pump for maintaining a desired amount of pressure in a vehicle of claim 18, said pump assembly further comprising:
an electroactive polymer material for generating an electrical charge;
a battery in electrical communication with said electroactive polymer material, such that said electroactive polymer material generates energy to be stored by said battery; and
an electronic pump in electrical communication with said battery such that when said electronic pump receives energy from said battery, said electronic pump is operable to pump air into said tire.

22. The micro-pump for maintaining a desired amount of pressure in a vehicle of claim 21, said electroactive polymer material further comprising:
a patch of said electroactive polymer material located on an inside surface of said tire, said patch of material creating said electric charge when it is flexed and/or elongated during vehicle travel.

23. The micro-pump for maintaining a desired amount of pressure in a vehicle of claim 21, said pump assembly further comprising:
a valve stem, said valve stem at least partially over-molded with said electroactive polymer material to form an electroactive polymer stem operable for fluttering during vehicle travel to create said electric charge.

24. A method for controlling the air pressure in a tire, comprising the steps of:
providing a generation of power;
converting said power;
releasing said power;
generating a pumping action by said releasing said power;
monitoring air pressure in a tire; and
controlling the activation or deactivation of said generation of said power to maintain said air pressure in said tire.

25. The method of claim 24, the step of said generation of said power is achieved by the step of selecting one from the group consisting of capturing kinetic energy, centrifugal forces, air movement, pressure changes, temperature changes, electroactive polymer charge generation, and combinations thereof.

26. The method of claim 24, the step of converting said power is achieved by the step of selecting one from the group consisting of a primary gear set, belts and pulleys, levers, air canisters, a generator, a capacitor, a battery, and combinations thereof.

27. The method of claim 26, the step of storing said power further comprising the step of winding a spring.

28. The method of claim 27, the step of releasing said power further comprising the step of releasing said spring.

29. The method of claim 24, the step of generating a pumping action further comprising the step of pumping air.

30. The method of claim 29, further comprising the step of selecting one from the group consisting of diaphragm pump, a piston pump, a turbine pump, a rotary pump, an electro piezo pump, an electro magnet pump, and combinations thereof for pumping said air.

31. The method of claim 24, the step of monitoring said air pressure in said tire is achieved by the step of selecting one from the group consisting of a regulator valve, a pressure transducer, a piezo, a pressure regulator, and combinations thereof.

32. The method of claim 24, the step of controlling said generating of said power in said tire through the use of one selected from the group consisting of solenoid, a lever, a cam, a circuit board having software, a catch, a slot, and combinations thereof.
